(19) United States
(12) Patent Application Publication
(10) Pub. No.: US 2021/0043967 A1
(43) Pub. Date: Feb. 11, 2021

(54) STABILIZING THE ALKALI METAL-SOLID ELECTROLYTE INTERFACE THROUGH EXTERNAL VARIABLE CONTROL

(71) Applicant: The Regents of the University of Michigan, Ann Arbor, MI (US)

(72) Inventors: Jeff Sakamoto, Ann Arbor, MI (US); Maria Garcia Mendez, Ann Arbor, MI (US); Neil Dasgupta, Ann Arbor, MI (US); Eric Kazyak, Ann Arbor, MI (US)

(21) Appl. No.: 16/989,059

(22) Filed: Aug. 10, 2020

Related U.S. Application Data
(60) Provisional application No. 62/885,107, filed on Aug. 9, 2019.

(51) Int. Cl. H01M 10/0562; H01M 4/134; H01M 4/38; H01M 10/058; H01M 10/0525; H01M 10/42

(52) U.S. Cl. CPC H01M 10/0562; H01M 4/134; H01M 4/382; H01M 2004/027; H01M 10/0525; H01M 10/4285; H01M 10/058

(57) ABSTRACT

Disclosed are electrochemical devices, such as lithium metal batteries using a solid state electrolyte. A means is disclosed to achieve relevant charging rates without short-circuiting a cell of the electrochemical device by limiting the electrode area, positioning the electrode where least defect population exist and controlling the external variables for stable lithium electrodeposition. Also disclosed is a method for visualizing metal propagation from an anode into a solid state electrolyte during cycling of an electrochemical cell comprising the anode and the solid state electrolyte.

### CROSS-REFERENCES To RELATED APPLICATIONS

This application claims priority to U.S. Patent Application No. 62/885,107 filed Aug. 9, 2019.

### STATEMENT REGARDING FEDERALLY SPONSORED RESEARCH

This invention was made with government support under grant number DE-AR-0000653 awarded by Advanced Research Projects Agency. The government has certain rights in this invention.

### FIELD OF THE INVENTION

This invention relates to electrochemical devices, such as lithium battery electrodes, lithium ion conducting solid state electrolytes, and solid-state lithium ion batteries including these electrodes and solid state electrolytes. The maximum charging rate a solid-state battery can withstand without short-circuiting can be affected by defects on the microstructure of the solid electrolyte, resulting from processing, but also the variables at which the cell is tested. In this disclosure, we describe a means to achieve relevant charging rates without short-circuiting the cell by limiting the electrode area, positioning the electrode where least defect population exist and controlling the external variables for stable lithium electrodeposition.

### BACKGROUND

Current state of the art lithium ion batteries comprise two electrodes (an anode and a cathode), a separator material that keeps the electrodes from touching but allows Li+ ions through, and an electrolyte (which is an organic liquid with lithium salts). During charge and discharge, Li+ ions are exchanged between the electrodes. Currently, the liquid electrolyte used in state of the art (SOA) Li-ion batteries is not compatible with advanced battery concepts, such as the use of a lithium metal anode. All-solid-state batteries (ASSB) with lithium metal as an anode with higher energy density compared to SOA Li-ion battery technology are of interest since they have the potential to meet the electrochemical energy storage demands for applications such as electric vehicles and microelectronics. Moreover, the replacement of a flammable liquid electrolyte with a solid electrolyte (SE), can address safety concerns. Despite significant progress made in achieving ionic conductivities commensurate with liquid electrolytes and achieving low Li-SE interface resistance, the maximum charge rate does not match that of Li-ion technology (≥1C or ˜3 mA/cm²). It has been observed that at charging current densities in the 0.1 to 1 mA/cm² range, Li metal penetrates all bulk-scale solid electrolytes (polymers, sulfide-based ceramics, oxide-based ceramics), manifested as a potential of ˜0 V, or short-circuit, across the cell under galvanostatic testing. This maximum tolerable current density at and above which Li penetration occurs is also known as critical current density (CCD).

Optimizing the CCD of a solid electrolyte is one of the last major challenges impeding commercialization of ASSB since the Li propagation mechanism has not been clearly elucidated. Generally, a fundamental understanding of the mechanism is challenging given that characterizing a Li-SE buried interface and correlating it to the electrochemical behavior observed is particularly difficult. Furthermore, replacing a liquid with a solid introduces additional challenges compared to SOA Li-ion; such as non-intimate contact between electrolyte and electrode causing an inhomogeneous current distribution across the interface. Additionally, Li with a strong reduction potential, readily forms interfacial layers between the electrode and the electrolyte that not necessarily are ionic conductors impeding charge transfer across materials.

The CCD at which lithium metal penetrates the solid electrolyte is not necessarily an intrinsic property, rather, it is likely an extensive property affected by defects/variables such as porosity, grain boundary and interface resistance, temperature and pressure. These defects/variables can play a role on the creation of ionic current focusing effects or “hot spots” resulting in the localized exceeding of the CCD. Moreover, exceeding the CCD often results in fracture of the solid electrolyte, suggesting there is an existing critical flaw size that when surpassed results in crack propagation of the solid electrolyte. Thus, control over the solid electrolyte microstructure resulting from processing and the variables at which the cell is tested can play a key role in controlling CCD.

What is needed are methods for raising the critical current density for solid-state batteries.

### SUMMARY OF THE INVENTION

As described above, the critical current density can be affected by defects on the microstructure of the solid electrolyte, resulting from processing, but also the variables at which the cell is tested. In this disclosure, we describe a means to achieve relevant charging rates without short-circuiting the cell by limiting the electrode area, positioning the electrode where least defect population exist and controlling the external variables for stable Li electrodeposition.

In one aspect, the present disclosure provides an electrochemical device comprising: a cathode; a solid state electrolyte including a side having an electrolyte perimeter defining a surface area of the side of the solid state electrolyte; and an anode including a surface region having an anode perimeter defining the surface region of the anode, the surface region of the anode being in contact with the solid state electrolyte wherein at least a portion of the anode perimeter is spaced inward of the electrolyte perimeter. In one version of the electrochemical device, the entire anode perimeter can be spaced inward of the electrolyte perimeter. An area of the surface region of the anode can be a percentage or less than the surface area of the side of the solid state electrolyte, wherein the percentage is an integer between 0 and 100. The area of the surface region of the anode can be 90% or less than the surface area of the side of the solid state electrolyte. The area of the surface region of the anode can be 60% or less than the surface area of the side of the solid state electrolyte. The area of the surface region of the anode can be 30% or less than the surface area of the side of the solid state electrolyte.

In one version of the electrochemical device, the solid-state electrolyte comprises a material selected from the group consisting of lithium lanthanum zirconium oxide (LLZO), aluminum doped LLZO, tantalum doped LLZO, lithium aluminum titanium phosphate (LATP), lithium aluminum germanium phosphate (LAGP), lithium phosphorous sulfides, alkali metal cation-alumina, metal halides, and mixtures thereof.

In another version of the electrochemical device, the solid-state electrolyte comprises a material having the formula LiᵤReᵥM_{w}AₓO_{y}, wherein

Re can be any combination of elements with a nominal valance of +3 including La, Nd, Pr, Pm, Sm, Sc, Eu, Gd, Tb, Dy, Y, Ho, Er, Tm, Yb, and Lu;

M can be any combination of metals with a nominal valance of +3, +4, +5 or +6 including Zr, Ta, Nb, Sb, W, Hf, Sn, Ti, V, Bi, Ge, and Si;

A can be any combination of dopant atoms with nominal valance of +1, +2, +3 , or +4 including H, Na, K, Rb, Cs, Ba, Sr, Ca, Mg, Fe, Co, Ni, Cu, Zn, Ga, Al, B, and Mn;

u can vary from 3-7.5;

v can vary from 0-3;

w can vary from 0-2;

x can vary from 0-2; and

y can vary from 11-12.5.

In another version of the electrochemical device, the solid-state electrolyte comprises a lithium phosphorous sulfide.

In one version of the electrochemical device, the area of the surface region of the anode is less than 10 mm². In another version of the electrochemical device, the area of the surface region of the anode is less than 2 mm².

In one version of the electrochemical device, a critical current density of the electrochemical device can be 2 mA/cm² or greater. In another version of the electrochemical device, the critical current density of the electrochemical device can be 1 mA/cm² or greater.

In one version of the electrochemical device, the anode comprises lithium, magnesium, sodium, or zinc. In another version of the electrochemical device, the anode consists essentially of lithium metal.

In another aspect, the present disclosure provides a method for forming an electrochemical device. The method comprises: (a) providing a solid state electrolyte including a side having an electrolyte perimeter defining a surface area of the side of the solid state electrolyte; and (b) placing the side of the solid state electrolyte in contact with a surface region of an electrode to form the electrochemical device, wherein the surface region of the electrode has an electrode perimeter defining the surface region of the electrode, wherein at least a portion of the electrode perimeter is spaced inward of the electrolyte perimeter. In one version of the method, the entire electrode perimeter is spaced inward of the electrolyte perimeter. In one version of the method, an area of the surface region of the electrode is a percentage or less than the surface area of the side of the solid state electrolyte, and the percentage is an integer between 0 and 100. In another version of the method, the area of the surface region of the electrode can be 90% or less than the surface area of the side of the solid state electrolyte. In another version of the method, the area of the surface region of the electrode can be 60% or less than the surface area of the side of the solid state electrolyte. In another version of the method, the area of the surface region of the electrode can be 30% or less than the surface area of the side of the solid state electrolyte.

In one version of the method, the solid-state electrolyte comprises a material selected from the group consisting of lithium lanthanum zirconium oxide (LLZO), aluminum doped LLZO, tantalum doped LLZO, lithium aluminum titanium phosphate (LATP), lithium aluminum germanium phosphate (LAGP), lithium phosphorous sulfides, alkali metal cation-alumina, metal halides, and mixtures thereof.

In another version of the method, the solid-state electrolyte comprises a material having the formula LiᵤReᵥM_{w}AₓO_{y}, wherein

Re can be any combination of elements with a nominal valance of +3 including La, Nd, Pr, Pm, Sm, Sc, Eu, Gd, Tb, Dy, Y, Ho, Er, Tm, Yb, and Lu;

M can be any combination of metals with a nominal valance of +3, +4, +5 or +6 including Zr, Ta, Nb, Sb, W, Hf, Sn, Ti, V, Bi, Ge, and Si;

A can be any combination of dopant atoms with nominal valance of +1, +2, +3 , or +4 including H, Na, K, Rb, Cs, Ba, Sr, Ca, Mg, Fe, Co, Ni, Cu, Zn, Ga, Al, B, and Mn;

u can vary from 3-7.5;

v can vary from 0-3;

w can vary from 0-2;

x can vary from 0-2; and

y can vary from 11-12.5.

In another version of the method, the solid-state electrolyte comprises a lithium phosphorous sulfide.

In one version of the method, an area of the surface region of the electrode can be less than 10 mm². In another version of the method, the area of the surface region of the electrode can be less than 2 mm².

In one version of the method, step (b) comprises pressing the solid state electrolyte and the electrode together using a force in a range of 0.01 MPa to 10 MPa.

In another version of the method, step (b) comprises placing the side of the solid state electrolyte in contact with the surface region of the electrode to form the electrochemical device, wherein the surface region of the electrode is at least partially melted.

In one version of the method, the electrode consists essentially of an alkali metal, and step (b) comprises pressing the solid state electrolyte and the electrode together using a load that is higher than a yield strength of the alkali metal. In one version of the method, the electrode consists essentially of lithium metal.

In another aspect, the present disclosure provides a method for visualizing metal propagation from an anode into a solid state electrolyte during cycling of an electrochemical cell comprising the anode and the solid state electrolyte. The method comprises: (a) providing an electrochemical cell comprising a cathode, an anode, and a solid state electrolyte, wherein the anode comprises a metal; (b) repeatedly discharging and thereafter charging the cell at a current density; and (c) recording metal propagation from the anode into the solid state electrolyte using video microscopy time-synchronized to applied current density. The method can further comprise: (d) quantifying metal filament propagation as a function of the applied current density. The method can further comprise: (d) recording voltage response of the cell during galvanostatic plating of the metal. The method can further comprise: (d) imaging an interface of the anode and the solid state electrolyte after galvanostatic plating of the metal.

In one version of the method, step (a) can comprise providing an electrochemical cell comprising a stack of the cathode, the anode, and the solid state electrolyte, and step (c) can comprise recording metal propagation from the anode into the solid state electrolyte using video microscopy in a viewing direction toward a cross-section of the stack of the cathode, the anode, and the solid state electrolyte. In another version of the method, step (a) can comprise providing an electrochemical cell comprising a solid state electrolyte having a surface, a cathode deposited on the surface of the solid state electrolyte, and an anode deposited on the surface of the solid state electrolyte in spaced relationship with the cathode, and step (c) can comprise recording metal propagation from the anode into the solid state electrolyte using video microscopy in a viewing direction toward the surface of the solid state electrolyte.

In another aspect, the present disclosure provides a method for charging an electrochemical device having a cathode, an anode, and a solid state electrolyte. The method comprises: selecting a charging current density based on accumulated/irreversible damage of a cell of the electrochemical device. The method can further comprise: determining the accumulated/irreversible damage by detecting deviation from ohmic behavior when applying a current density to the cell. In one version of the method, the anode comprises lithium, magnesium, sodium, or zinc. In another version of the method, the anode consists essentially of lithium metal.

The foregoing and other aspects and advantages of the invention will appear from the following description. In the description, reference is made to the accompanying drawings which form a part hereof, and in which there is shown by way of illustration an example embodiment of the invention. Such embodiment does not necessarily represent the full scope of the invention, however, and reference is made therefore to the claims and herein for interpreting the scope of the invention.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 is a schematic of a lithium metal battery.

FIG. 2 shows the most probable critical flaw size (assuming a circle in geometry) for a solid state electrolyte microstructure.

FIG. 3 shows critical current density in Li|Al-doped LLZO symmetric cells as a function of electrode area located at the center of the sample.

FIG. 4 shows critical current density in Li|Ta-doped LLZO symmetric cells as a function of electrode area located at the center of the sample.

FIG. 5 shows critical current density in Li|Al-doped LLZO symmetric cells as a function of electrode area located at the edge of the sample (between ⅜ to ½″ or 4.76 to 6.35 mm, going radially).

FIG. 6 shows a Li|LLZO symmetric cell under galvanostatic testing at 1 mA cm⁻² wherein the left graph shows stripping and plating of Li without stack pressure showing significant overpolarization upon stripping, and wherein the right graph shows stripping and plating of Li under 5.6 MPa onto the Li electrode.

FIG. 7 shows irreversible damage manifested as non-linear potential behavior in a Li|LLZO symmetric cell at 80° C.

FIG. 8A shows a galvanostatic test of a Li|LLZO symmetric cell with fixed areal charge of 0.25 mAh cm⁻² per half cycle with current density segments from 0.1 to 2 mA cm⁻², 0.1 mA cm⁻² increments, critical current density (CCD) of 1.2 mA cm⁻². CCD is increased as the irreversible damage/deviation in linear behavior of the potential is minimized.

FIG. 8B shows a galvanostatic test of a Li|LLZO symmetric cell with fixed areal charge of 0.25 mAh cm⁻² per half cycle with current density segments of 1 and 5 mA cm⁻², CCD of 5 mA cm⁻². CCD is increased as the irreversible damage/deviation in linear behavior of the potential is minimized.

FIG. 9 shows the quantification of porosity as a function of radial position for a solid state electrolyte.

FIG. 10A shows the most critical flaw area for Map position 1 of FIG. 9.

FIG. 10B shows the most critical flaw area for Map position 2 of FIG. 9.

FIG. 10C shows the most critical flaw area for Map position 3 of FIG. 9.

FIG. 10D shows the most critical flaw area for Map position 4 of FIG. 9.

FIG. 10E shows the most critical flaw area for Map position 5 of FIG. 9.

FIG. 10F shows the most critical flaw area for Map position 6 of FIG. 9.

FIG. 11 shows through-plane cycling in LLZO with operando cross-sectional visualization. Images, schematic, and electrochemical data from operando through-plane Li/LLZO/Li cell wherein (A) shows schematic showing cell geometry, wherein (B) shows voltage response of cell during galvanostatic plating at 0.5 mA/cm², wherein (C) shows post-mortem image of active area of electrode interface that was plated to, wherein (D-G) show image series from through-plane visualization cell.

FIG. 12 shows a demonstration of in-plane visualization platform wherein (A) shows schematic representation of in-plane cell geometry and experimental setup, wherein (B,C) show images of in-plane Li/LLZO/Li cell before and after Li penetration and short-circuit, wherein (D) shows voltage response of cell during stepped current, with zoom-in shown in (E), wherein (F) shows Nyquist plots of in-plane cell before and after cycling until short-circuit, and wherein (G) shows image showing pellet with multiple in-plane cells deposited on the surface.

FIG. 13 shows different types or morphologies of Li penetration. Optical images, SEM images, and schematics of straight Li penetration type (A-C), branching type (D-F), spalling type (G-I), and diffuse type (J-L). Contrast and brightness adjustments were made to the entire image in (A, J) to make features more evident in in-situ optical images.

FIG. 14 shows cross-sectional analysis of branching-type Li filament. Post-mortem characterization of Li penetration morphology with scanning electron and optical microscopy. Secondary (A,D) and backscattered (E) electron images of LLZO cross-section through branching-type Li filament at location shown in the optical images shown in (B). Optical image of same area of cross-section shown in (C).

FIG. 15 shows cross-sectional analysis of spalling-type Li filament. Characterization of Li penetration morphology with scanning electron and optical microscopy. Secondary (A,C,E) and backscattered (B) electron images of focused ion beam (FIB) cross-sections through spalling-type Li filaments. Top-down (D) and cross-sectional (F) optical images of the same feature shown in (C).

FIG. 16 shows reversibility and cyclability of Li filaments—First cycle. (A) Optical image of in-plane Li/LLZO/Li cell at end of first half-cycle at 75 mA/cm², (B) corresponding voltage trace, (C) image during second half-cycle before Li is exhausted from filament structures on the left, (D) corresponding voltage trace, (E) image at point in second half-cycle when filament structures are exhausted of Li (disappear from view), (F) corresponding voltage trace, (G) image from end of second half cycle, and (H) corresponding voltage trace.

FIG. 17 shows reversibility and cyclability of Li filaments—Subsequent cycles. (A) Voltage profile of in-plane Li/LLZO/Li cell during galvanostatic cycling at 5 mA/cm² and 10 mA/cm² with points in time labelled corresponding to the operando optical images in (B-L).

FIG. 18 shows analysis of Li propagation rate. (A-C) Schematic representation of Li propagation and relaxation inside of a crack, (D) representative operando optical image of a Li-filled crack with areas analyzed in (F) and FIG. 19 labelled, (E) Plot of crack growth over time during a representative set of current pulses, with a hyperbolic tangent fit of the curve that was used to track crack position, (F) plot of pixel brightness vs. position along a line across the crack tip for frames during and after a current pulse, and (G) plot of crack growth rate vs. applied current.

FIG. 19 shows electron and optical microscopy images of straight type crack propagation. (A,B) SEM images of Li that has been extruded out of the crack where it intersects the surface of the LLZO pellet. (C,D) Operando optical images of straight type Li penetration.

FIG. 20 shows an analysis of in-plane Li/LLZO/Li cell behavior during extended galvanostatic plating. (A-C) Operando optical images at different points in time during Li plating, (D) voltage response to the 4 mA/cm² current pulses with inset showing voltage decay after the current pulses for selected pulses, (E) Area-specific resistance (based on the initial electrode areas) of interface, bulk, and total from EIS after each current pulse. (F) Interface capacitance and apparent electrode area after each current pulse. (G) Schematics of void formation at high current densities. (H) Optical images of anode after each current pulse, processed using thresholding and outlier removal in imageJ so that white area represents metallic Li.

FIG. 21 shows cross-sectional SEM images of FIB-cut Li/LLZO interfaces. (A) after stripping, and (B) after plating.

FIG. 22 shows a demonstration of in-plane visualization architecture in glassy lithium phosphorous sulfide (LPS). (A,B) Operando optical images of in-plane Li/LPS/Li cell before and after Li penetration. (C) Electrochemical data from cycling of the same cell, with insets (D,E) showing zoom-in on a cycles before and during Li filament nucleation.

FIG. 23 shows: in (A), applied current density and measured cell polarization as current is increased in the through-plane cell; in (B), an optical image of active area of cell after the Li electrode was removed and the interface was gently sanded to reveal the base of the Li filaments; and in (C), EIS before cycling and after short-circuit.

FIG. 24 shows a Nyquist plot of in-plane cell with as-deposited Li metal electrodes (prior to annealing) with inset of the equivalent circuit model used to fit the EIS data collected throughout this disclosure.

FIG. 25 shows the highest safe current density and cell polarization for each of the in-plane cells with annealed Li electrodes.

FIG. 26 shows: in (A), an optical image of straight-type Li filament used for crack growth rate measurements in FIG. 31; in (B), an SEM image of FIB-cut cross-section through Li filament shown in (A); and in (C), Z-profile of Li filament shown in (A,B) collected from optical microscopy with a Keyence microscope.

FIG. 27 shows X-ray diffraction phase analysis with fitted curve and resulting phase content.

FIG. 28 shows presence/absence plot for branching-type Li filaments, and the current density at which nucleation occurred for each of the in-plane cells tested.

FIG. 29 shows optical images of the same branching type Li filament with different lighting, as labelled in the panels. CP stands for cross-polarization.

FIG. 30 shows: in (A), representative frame from operando imaging during pulsed crack growth experiment with lines overlaid where pixel brightness values were extracted; and in (B), extracted pixel brightness values after normalization, along with the hyperbolic tangent fit that was used to track crack-tip position over time.

FIG. 31 shows: in (A), optical image of Li filament that propagated along the scratch made by a diamond scribe, and then extended beyond to where the operando crack-growth rate experiments were conducted; and in (B), higher magnification image at the tip of the feature shown in (A).

The invention will be better understood and features, aspects and advantages other than those set forth above will become apparent when consideration is given to the following detailed description thereof. Such detailed description makes reference to the drawings.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The term “critical current density (CCD)” as used herein refers to the maximum tolerable current density at and above which Li penetration through a solid electrolyte occurs.

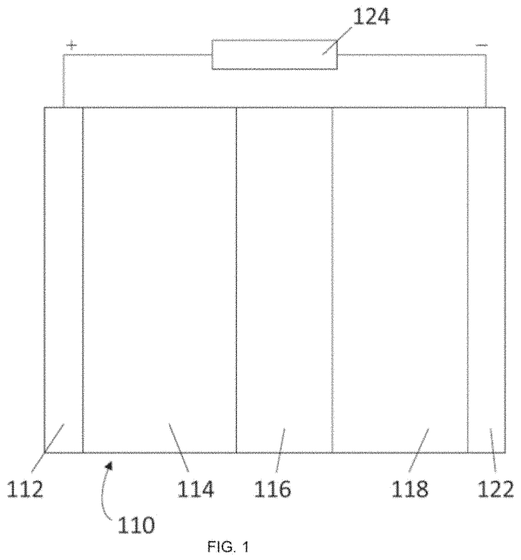

One embodiment described herein relates to a method for raising the critical current density for solid-state batteries. In one non-limiting example application, a solid state electrolyte 116 can be used in a lithium metal battery 110 as depicted in FIG. 1. The lithium metal battery 110 includes a current collector 112 (e.g., aluminum) in contact with a cathode 114. A solid state electrolyte 116 is arranged between the cathode 114 and an anode 118, which is in contact with a current collector 122 (e.g., aluminum). The current collectors 112 and 122 of the lithium ion battery 10 may be in electrical communication with an electrical component 124. The electrical component 124 could place the lithium metal battery 110 in electrical communication with an electrical load that discharges the battery or a charger that charges the battery.

The first current collector 112 and the second current collector 122 can comprise a conductive metal or any suitable conductive material. In some embodiments, the first current collector 112 and the second current collector 122 comprise aluminum, nickel, copper, combinations and alloys thereof. In other embodiments, the first current collector 112 and the second current collector 122 have a thickness of 0.1 microns or greater. It is to be appreciated that the thicknesses depicted in FIG. 1 are not drawn to scale, and that the thickness of the first current collector 112 and the second current collector 122 may be different.

A suitable active material for the cathode 114 of the lithium metal battery 110 is a lithium host material capable of storing and subsequently releasing lithium ions. An example cathode active material is a lithium metal oxide wherein the metal is one or more aluminum, cobalt, iron, manganese, nickel and vanadium. Non-limiting example lithium metal oxides are LiCoO₂ (LCO), LiFeO₂, LiMnO₂ (LMO), LiMn₂O₄, LiNiO₂ (LNO), LiNixCo_{y}O₂, LiMnₓCo_{y}O₂, LiMnₓNi_{y}O₂, LiMnₓNi_{y}O₄, LiNiₓCo_{y}Al_{z}O₂, LiNi_{1/3}Mn_{1/3}Co_{1/3}O₂ and others. Another example of cathode active materials is a lithium-containing phosphate having a general formula LiMPO₄ wherein M is one or more of cobalt, iron, manganese, and nickel, such as lithium iron phosphate (LFP) and lithium iron fluorophosphates. Many different elements, e.g., Co, Mn, Ni, Cr, Al, or Li, may be substituted or additionally added into the structure to influence electronic conductivity, ordering of the layer, stability on delithiation and cycling performance of the cathode materials. The cathode active material can be selected from the group consisting of cathode materials having a formula LiNiₓMn_{y}Co_{z}O₂, wherein x+y+z=1 and x:y:z=1:1:1 (NMC 111), x:y:z=4:3:3 (NMC 433), x:y:z=5:2:2 (NMC 522), x:y:z=5:3:2 (NMC 532), x:y:z=6:2:2 (NMC 622), or x:y:z=8:1:1 (NMC 811). The cathode active material can be a mixture of any number of these cathode active materials. In other embodiments, a suitable material for the cathode 114 of the lithium battery 110 is porous carbon (for a lithium air battery), or a sulfur containing material (for a lithium sulfur battery).

In some embodiments, a suitable active material for the anode 118 of the lithium metal battery 110 consists of lithium metal. In other embodiments, an example anode 118 material consists essentially of lithium metal. Alternatively, a suitable anode 118 consists essentially of magnesium, sodium, or zinc metal.

An example solid state electrolyte 116 material for the lithium metal battery 110 can include an electrolyte material having the formula LiᵤReᵥM_{w}AₓO_{y}, wherein Re can be any combination of elements with a nominal valance of +3 including La, Nd, Pr, Pm, Sm, Sc, Eu, Gd, Tb, Dy, Y, Ho, Er, Tm, Yb, and Lu;

M can be any combination of metals with a nominal valance of +3, +4, +5 or +6 including Zr, Ta, Nb, Sb, W, Hf, Sn, Ti, V, Bi, Ge, and Si;

A can be any combination of dopant atoms with nominal valance of +1, +2, +3 or +4 including H, Na, K, Rb, Cs, Ba, Sr, Ca, Mg, Fe, Co, Ni, Cu, Zn, Ga, Al, B, and Mn;

u can vary from 3-7.5;

v can vary from 0-3;

w can vary from 0-2;

x can vary from 0-2; and

y can vary from 11-12.5.

Li₇La₃Zr₂O₁₂ (LLZO) materials are beneficial for use as the solid state electrolyte 116 material for the lithium metal battery 110.

Another example solid state electrolyte 116 can include any combination oxide or phosphate materials with a garnet, perovskite, NaSICON, or LiSICON phase. Another example solid state electrolyte 116 can include lithium phosphorous sulfide (e.g., 75Li₂S-25P₂S₅(mol %), 80Li₂S-20P₂S₅(mol %)), lithium aluminum titanium phosphate (LATP), lithium aluminum germanium phosphate (LAGP), alkali metal cation-alumina (e.g., sodium-β-alumina and sodium-β″-alumina), metal halides, or mixtures thereof. The solid state electrolyte 116 of the lithium metal battery 110 can include any solid-like material capable of storing and transporting ions between the anode and cathode, so long as the solid-like material has negligible electronic conductivity and is electrochemically stable against high voltage cathodes and lithium metal anodes.

In the lithium metal battery 110, the solid state electrolyte 116 can include a side having an electrolyte perimeter defining a surface area of the side of the solid state electrolyte 116. The anode 118 can include a surface region having an anode perimeter defining the surface region of the anode 118, the surface region of the anode 118 being in contact with the solid state electrolyte 116. In one embodiment, at least a portion of the anode perimeter is spaced inward of the electrolyte perimeter. In another embodiment, the entire anode perimeter of the anode 118 is spaced inward of the electrolyte perimeter of the solid state electrolyte 116. In another embodiment, an area of the surface region of the anode 118 is a percentage or less than the surface area of the side of the solid state electrolyte 116, and the percentage is an integer between 0 and 100. For example, the area of the surface region of the anode 118 can be 90% or less than the surface area of the side of the solid state electrolyte 116; or the area of the surface region of the anode 118 can be 80% or less than the surface area of the side of the solid state electrolyte 116; or the area of the surface region of the anode 118 can be 70% or less than the surface area of the side of the solid state electrolyte 116; or the area of the surface region of the anode 118 can be 60% or less than the surface area of the side of the solid state electrolyte 116; or the area of the surface region of the anode 118 can be 50% or less than the surface area of the side of the solid state electrolyte 116; or the area of the surface region of the anode 118 can be 40% or less than the surface area of the side of the solid state electrolyte 116; or the area of the surface region of the anode 118 can be 30% or less than the surface area of the side of the solid state electrolyte 116; or the area of the surface region of the anode 118 can be 20% or less than the surface area of the side of the solid state electrolyte 116; or the area of the surface region of the anode 118 can be 10% or less than the surface area of the side of the solid state electrolyte 116.

In one embodiment, an area of the surface region of the anode 118 is less than 10 mm². In another embodiment, the area of the surface region of the anode 118 is less than 8 mm². In another embodiment, the area of the surface region of the anode 118 is less than 6 mm². In another embodiment, the area of the surface region of the anode 118 is less than 4 mm². In another embodiment, the area of the surface region of the anode 118 is less than 2 mm².

In one embodiment, a critical current density of the lithium metal battery 110 is 2 mA/cm² or greater. In another embodiment, a critical current density of the lithium metal battery 110 is 1 mA/cm² or greater. In another embodiment, a critical current density of the lithium metal battery 110 is 0.5 mA/cm² or greater.

One example method for forming the lithium metal battery 110 comprises: (a) providing the solid state electrolyte 116 including a side having an electrolyte perimeter defining a surface area of the side of the solid state electrolyte 116; and placing the side of the solid state electrolyte 116 in contact with a surface region of the anode 118 to form the lithium metal battery 110, wherein the surface region of the anode 118 has an anode perimeter defining the surface region of the anode 118, wherein at least a portion of the anode perimeter of the anode 118 is spaced inward of the electrolyte perimeter of the solid state electrolyte 116. Optionally, the entire anode perimeter is spaced inward of the electrolyte perimeter. In the method, the area of the surface region of the anode 118 can be 90% or less than the surface area of the side of the solid state electrolyte 116; or the area of the surface region of the anode 118 can be 80% or less than the surface area of the side of the solid state electrolyte 116; or the area of the surface region of the anode 118 can be 70% or less than the surface area of the side of the solid state electrolyte 116; or the area of the surface region of the anode 118 can be 60% or less than the surface area of the side of the solid state electrolyte 116; or the area of the surface region of the anode 118 can be 50% or less than the surface area of the side of the solid state electrolyte 116; or the area of the surface region of the anode 118 can be 40% or less than the surface area of the side of the solid state electrolyte 116; or the area of the surface region of the anode 118 can be 30% or less than the surface area of the side of the solid state electrolyte 116; or the area of the surface region of the anode 118 can be 20% or less than the surface area of the side of the solid state electrolyte 116; or the area of the surface region of the anode 118 can be 10% or less than the surface area of the side of the solid state electrolyte 116.

In one embodiment of the method, an area of the surface region of the anode 118 is less than 10 mm². In another embodiment of the method, the area of the surface region of the anode 118 is less than 8 mm². In another embodiment of the method, the area of the surface region of the anode 118 is less than 6 mm². In another embodiment of the method, the area of the surface region of the anode 118 is less than 4 mm². In another embodiment of the method, the area of the surface region of the anode 118 is less than 2 mm².

In one embodiment of the method, the solid state electrolyte 116 and the anode 118can be pressed together using a force in a range of 0.01 MPa to 10 MPa. In another embodiment of the method, the surface region of the anode 118 is at least partially melted when placing the side of the solid state electrolyte 116 in contact with the surface region of the anode 118 to form the lithium metal battery 110. In another embodiment of the method, the anode 118 consists essentially of an alkali metal (e.g., lithium), and the solid state electrolyte 116 and the anode 118 are pressed together using a load that is higher than a yield strength of the alkali metal.

The invention also provides a method for visualizing metal propagation from an anode into a solid state electrolyte during cycling of an electrochemical cell comprising the anode and the solid state electrolyte. The method includes the steps of (a) providing an electrochemical cell comprising a cathode, an anode, and a solid state electrolyte, wherein the anode comprises a metal; (b) repeatedly discharging and thereafter charging the cell at a current density; and (c) recording metal propagation from the anode into the solid state electrolyte using video microscopy time-synchronized to applied current density. In one embodiment of this method, metal filament propagation is quantified as a function of the applied current density. In another embodiment of the method, the voltage response of the cell is recorded during galvanostatic plating of the metal. The interface of the anode and the solid state electrolyte may be imaged using electron microscopy after galvanostatic plating of the metal. In one embodiment of this method, the electrochemical cell comprises a stack of the cathode, the anode, and the solid state electrolyte, and metal propagation from the anode into the solid state electrolyte is recorded using video microscopy in a viewing direction toward a cross-section of the stack of the cathode, the anode, and the solid state electrolyte. In another embodiment of the method, the electrochemical cell comprises a solid state electrolyte having a surface, a cathode deposited on the surface of the solid state electrolyte, and an anode deposited on the surface of the solid state electrolyte in spaced relationship with the cathode, and metal propagation from the anode into the solid state electrolyte is recorded using video microscopy in a viewing direction toward the surface of the solid state electrolyte.

The invention also provides a method for charging an electrochemical device having a cathode, an anode, and a solid state electrolyte. The method comprises selecting a charging current density based on accumulated/irreversible damage of a cell of the electrochemical device. In the method, the accumulated/irreversible damage can be determined by detecting deviation from ohmic behavior when applying a current density to the cell.

### EXAMPLES

The following Examples are provided in order to demonstrate and further illustrate certain embodiments and aspects of the present invention and are not to be construed as limiting the scope of the invention.

### Example 1

### Defect Population and Its Effect on Electrode Area and Positioning

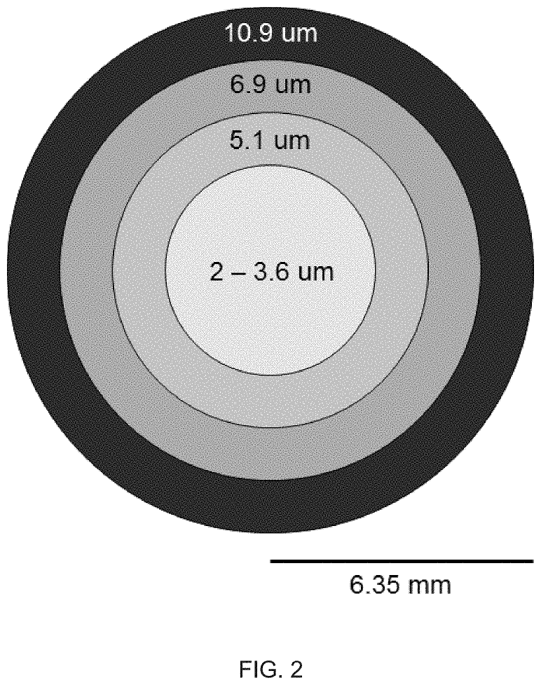

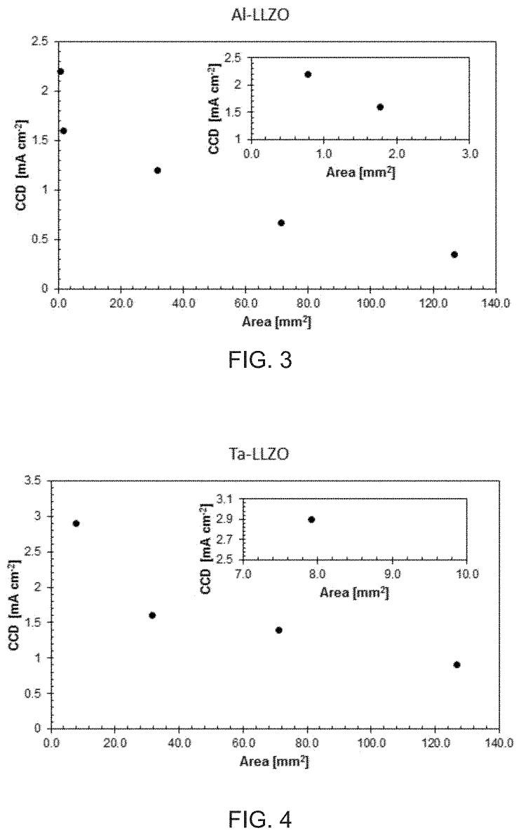

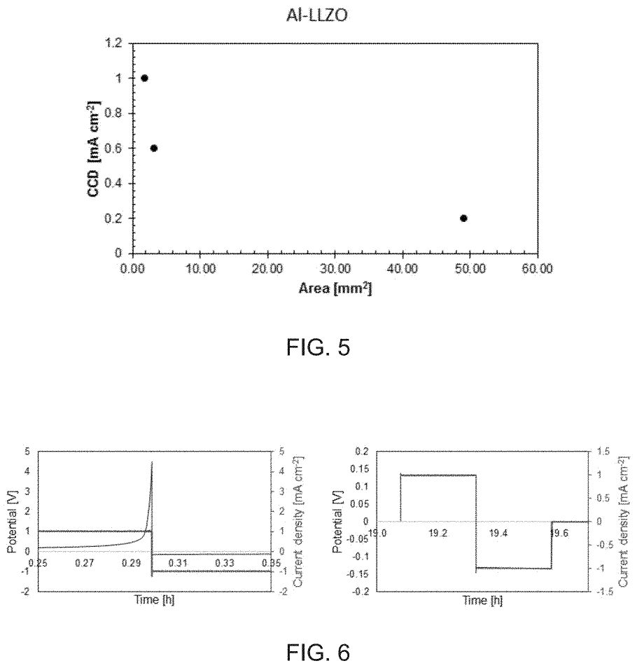

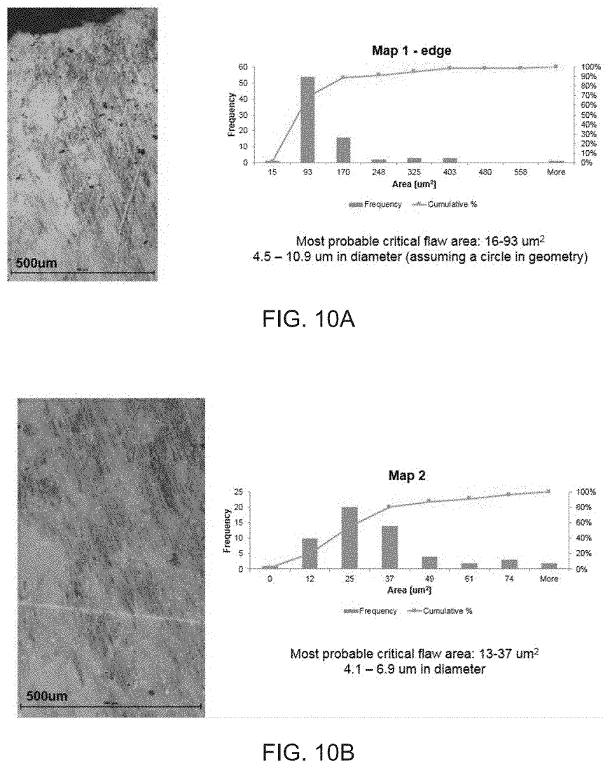

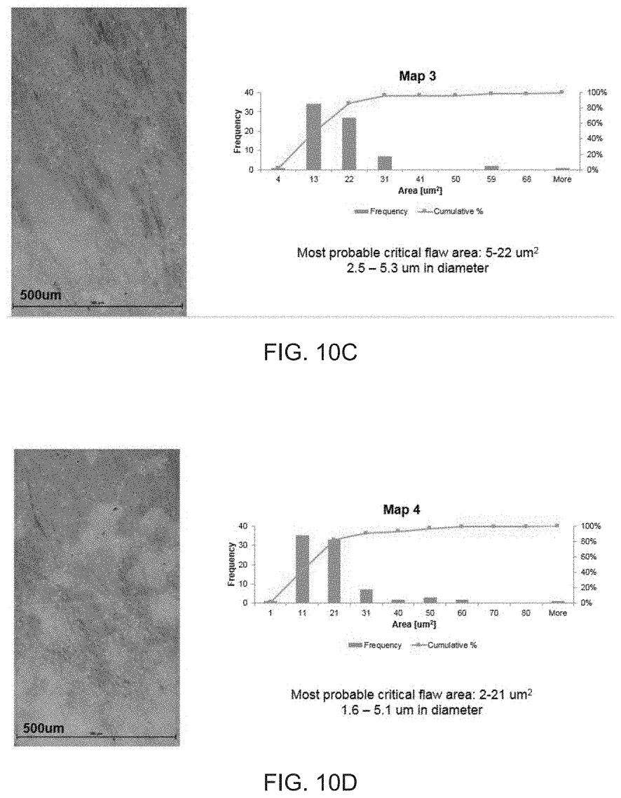

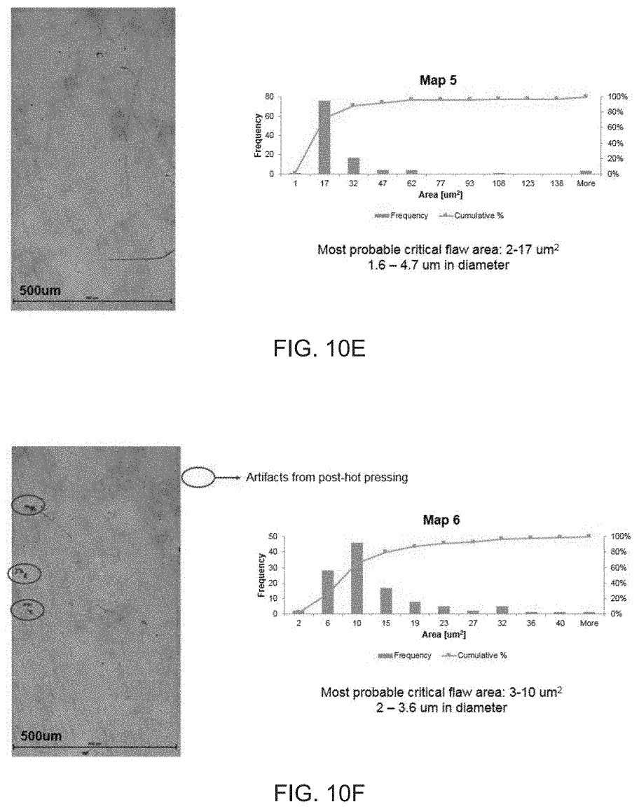

It has been observed that placement of the electrode in certain regions of the solid electrolyte and the area that is being cycled have a dramatic effect on the charging rate obtained under galvanostatic testing. It is believed that defect population size (flaw or pore size) is narrower the smaller the electrode is, but also microstructural defects vary as a function of radial position. Thus, the positioning of the electrode is a variable that enables higher critical current densities compared to regions near the edges of the sample where the defect population is larger even when the area is fixed (see FIGS. 3-5). For instance, pores in the garnet solid electrolyte microstructure as processed have been quantified (see FIGS. 9-10F) and four main regions have been discerned based on the critical flaw size (assuming a circle in geometry) as shown in FIG. 2.

The most probable critical flaw size is larger going radially from the center towards the edge of the sample, ranging from 2 μm near the center of the sample, going to ˜11 μm near the edges. In agreement, the critical current density values measured decreased as the electrode covers more of the sample area towards the edges. These defects are considered to be prone to act as ion current focusing points and stress concentrators at the interface between Li and the solid electrolyte acting as failure points. Moreover, the behavior observed suggests that this is a direct consequence of the way the ceramic has been processed (in a cylindrical die) indicating that there is an optimal effective area that results in better electrochemical performance of the solid electrolyte.

As shown in FIGS. 3-5, critical current density increases with decreasing electrode area due to lower defect population on the solid electrolyte that can act as ion current focusing points and stress concentrators at the interface between Li and the solid electrolyte acting as failure points. Critical current density increases as the alkali electrode is positioned towards the center of the solid electrolyte due to the decrease in flaw size going radially towards the center of the solid electrolyte.

Thus, the upper bound for the Li electrode area, assuming a square geometry, to achieve a specific charging rate with a doped LLZO solid electrolyte, should be (electrode located at the center of a 12.7 millimeter in diameter disk):

| | Current density range [mA cm⁻²] | | | | |
|---|---|---|---|---|---|
| Dopant | 0.5-0.9 | 1.0-1.4 | 1.5-1.9 | 2.0-2.4 | 2.5-2.9 |
| Aluminum | 8.4 × 8.4 mm | 5.6 × 5.6 mm | 1.3 × 1.3 mm | 0.9 × 0.9 mm | |
| Tantalum | 11.2 × 11.2 mm | 8.4 × 8.4 mm | 5.6 × 5.6 mm | | 2.8 × 2.8 mm |

### Pressure Dependence on Li Stripping and Plating

As previously mentioned, when two solid materials are put in contact in contrast to a liquid against a solid, intimate contact is not guaranteed. Furthermore, if there is a flux imbalance of Li at the interface, a depletion (or loss of contact area) can be manifested as overpolarization at the stripping interface (see left graph in FIG. 6). However, given that the electrochemical process that occurs at each interface in a Li symmetric cell is different (electrodeposition vs dissolution), the load dependence of each can be studied independently. More importantly, each process might have different requirements as the magnitude of the load required to aid the process. It has been observed that the stripping process is facilitated under stack pressure (higher than the yield strength of Li). This allows for Li to creep and act as a semi-infinite reservoir of Li, especially at higher current densities (≥0.5 mA cm⁻²), allowing to supply Li with almost negligible depletion. However, the plating process is not necessarily facilitated under load. FIG. 6 shows that a cell under no stack pressure on both sides results in a significant overpolarization during stripping, but negligible deviation from linear behavior on the plating side. If compared to a cell under stack pressure for both interfaces, at the same current density of 1 mA cm⁻², the potential response on the stripping side remains flat during the entire current density segment well as the plating side indicative of stable Li electrodeposition and dissolution. Stable Li stripping is facilitated by Li creep, thus, load applied to the interface should be higher than the yield strength of Li; 0.73-0.81 MPa (see Masias et al., “Elastic, plastic and creep mechanical properties of lithium metal,” Journal of Materials Science, vol. 54, no. 3, pp. 2585-2600, 2018) to avoid loss in contact area. Stable Li plating might require a load within 0.01-10 MPa range.

### Cumulative Charge and Its Effect on Critical Current Density

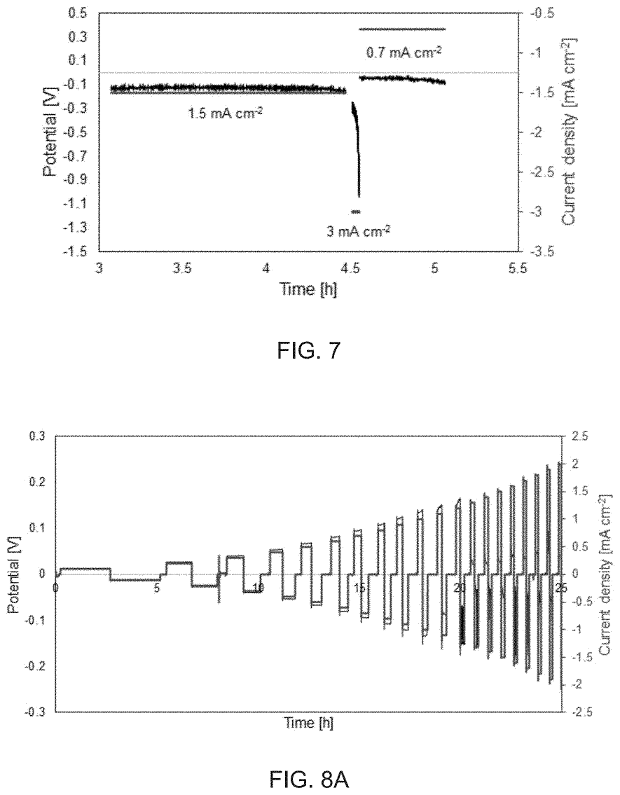

Additionally, non-linear potential response under galvanostatic testing is associated with irreversible damage onto the cell as shown in FIG. 7. Linear or ohmic behavior is observed at 1.5 mA cm⁻². When switching to a 3 mA cm⁻² current density segment, dramatic polarization is observed, or unstable Li plating. If the damage onto the cell was completely reversible the polarization behavior at a much lower current density, such as 0.7 mA cm⁻², should be linear or stable contrary what is measured. Thus, any deviation from linear behavior prior to reaching the critical current density of a solid electrolyte can be interpreted as accumulated/irreversible damage. This observation and results suggest that the accumulated charge passed through an electrolyte can have an effect on the critical current density measured.

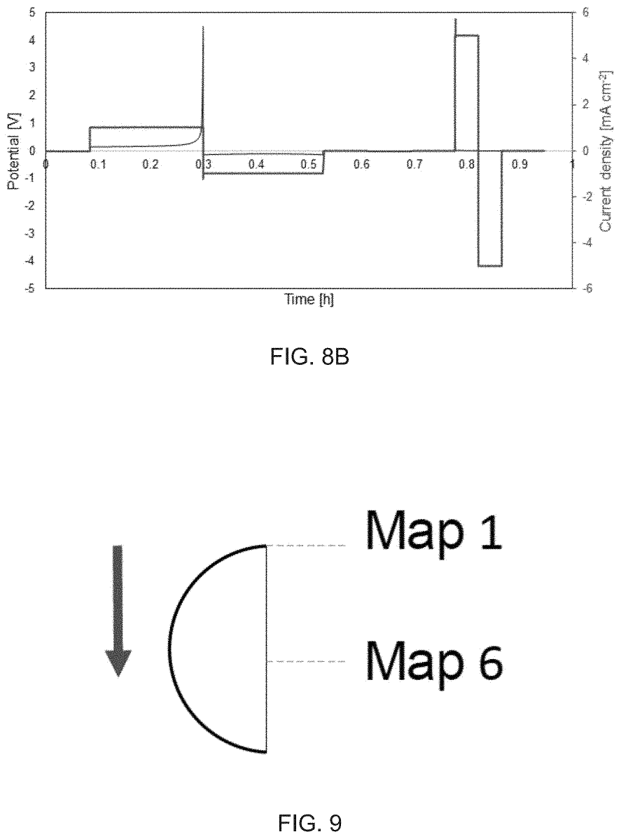

If comparing two cells, one that has gone through current density segments of 0.1 to 2 mA cm⁻² up to failure (short-circuit), 0.1 mA cm⁻² increments, and one that goes through 1, 5 mA cm⁻², both fixing charge to 0.25 mAh cm⁻² per half cycle and measured their CCD (FIGS. 8A and 8B, respectively), the values obtained are quite different, one being 1.2 and the other 5 mA cm⁻². The accumulated charge right before critical current density on the first one is 5.9 mAh cm⁻² as opposed to 0.51 mAh cm⁻² for the second one. This exemplifies that any deviation from ohmic behavior in lower current densities is accumulated damage, that when reaching higher current densities facilitates Li propagation through the cell. FIGS. 8A and 8B demonstrate that critical current density is increased as the irreversible damage/deviation in linear behavior of the potential is minimized.

### Example 2

Solid-state electrolytes (SSEs) have attracted substantial attention for next-generation batteries, primarily due to the promise of enabling Li metal electrodes. Despite significant progress, substantial challenges remain with interfacial stability. In many solid-state electrolyte (SSE) materials, Li metal filaments nucleate at high current densities and propagate until short-circuit. In this example, quantitative analysis of synchronized electrochemical responses and operando video microscopy paired with post-mortem electron microscopy revealed key new insights into the nature of Li filaments that propagate in SSEs. Li penetration was monitored during stepped current, galvanostatic cycling, pulsed current, and extended depth of discharge experiments to study the behavior under a wide variety of battery-relevant conditions. This example probes the coupled electrochemical-morphological-mechanical evolution of Li metal-SSE interfaces, which are critical to engineer the next-generation of solid-state batteries. Operando video microscopy was used to directly observe propagation and cycling of Li filaments inside superionic inorganic solid electrolytes at high current densities (>1 mA/cm²), providing mechanistic insights into one of the most critical challenges facing solid-state Li metal batteries.

Improvements in battery technology over the past several decades have enabled transformative changes to the way we live, travel, work, play, and communicate. From grid-scale storage to electric vehicles (EVs) to medical devices, the ability to efficiently store electrical energy and use it on-demand plays a key role in myriad applications. The demand for better batteries continues to grow, with vehicle electrification rapidly beginning to dominate total demand (Ref. 1). The goal of affordable long-range EVs with sufficiently fast charging time and improved safety has driven tremendous research effort in next-generation batteries with enhanced energy and power density (Ref. 2).

In particular, one of the most promising advances is switching from organic liquid electrolytes which are volatile and flammable to solid-state electrolytes (SSEs). In addition to the immediate improvement to the safety of these cells, this could enable the use of Li metal negative electrodes and next-generation chemistries such as Li-sulfur and Li-air, which could offer dramatically improved gravimetric/volumetric energy density (Ref. 3). To this end, numerous potential SSE materials have been developed in recent years, several of which show great promise (Ref. 4). These materials can be polymers, oxides, sulfides, halides, phosphates, and hydrides or composites thereof (Ref. 4). While each class has its own set of advantages and challenges, in many material systems, Li filaments tend to nucleate and grow towards the positive electrode at high current densities, eventually causing short-circuit (Ref. 5). The current density at which this occurs varies among different material systems. For example, in state of the art ceramic electrolytes, the critical current density (CCD) at which Li penetration occurs has been increased to above 1 mA/cm² through careful control of material processing (Ref. 6-9). However, increasing the CCD to higher current densities has been hindered by the lack of mechanistic insight into the origins of Li penetration/propagation. Understanding and overcoming this challenge is vital to the implementation of lithium metal solid-state batteries (LMSSBs) in applications where fast charging times are required, including EVs.

Several recent studies have attempted to elucidate the underlying mechanisms for the nucleation and growth of Li filaments/dendrites within SSEs, but a range of questions remained (Ref. 5, 7, 10-14). There is significant variation in the terminology used to describe these structures in literature, but we will use the general terms “Li filament” and “Li penetration”. Among the key remaining questions are when, why, and where Li penetration occurs, and what determines the path of propagation? Early work studied Li filament propagation in polycrystalline LLZO (Ref. 10). It was found that Li propagated in grain boundaries. However, whether or not filaments entered at grain boundaries could not be determined. Regardless, it is possible that grain boundaries could serve as preferential sites for nucleation and pathways for propagation (Ref. 10), and more recent computational work suggested that the localized mechanical properties at grain boundaries could be a rationale for this (Ref. 15). Porz et al. proposed a mechanical model that links the overpotential to stress within a Li-filled crack through chemical potential, and predicted a critical flaw size that would grow at a given applied overpotential (Ref. 5). This work studied several SSE systems, including single crystal Li₇La₃Zr₂O₁₂ (LLZO) and glassy Li₂S—P₂S₅ (lithium phosphorous sulfide), which demonstrates that Li filaments can propagate along paths other than grain boundaries. However, challenges with the experimental setup and geometry have made further validation of the model difficult, and the top-down or angled view of the through-plane cell limited observations of Li propagation (Ref. 16).

More recently, neutron depth profiling was applied to several SSE materials (Ref. 12). This study proposed a different underlying mechanism for nucleation of Li filaments that stems from the inherent electronic conductivity of the SSE. This mechanism was used to explain uniform, isolated accumulation of Li within the bulk of the SSE. Due to the limited spatial resolution of the technique, elevated temperatures were needed to observe changes, and the current densities applied were <200 μA/cm² at 298° K (Ref. 12). A similar mechanism was proposed by Song et al. (Ref. 17).

In addition to initiation of Li penetration, little is known about the dynamic evolution of Li metal electrodes during cycling and deep discharge conditions. Two recent studies examined the role of diffusion within the Li metal electrode on nucleation of Li filaments and on void formation at the Li/LLZO interface (Ref. 7, 13). These studies probed the diffusion of Li away from the cathodic interface and Li vacancies away from the anodic interface. Wang et al. hypothesized that if the diffusion of Li away from the interface cannot keep up with the rate of plating, there could be a build-up of Li at “hot-spots” that then act as a nucleation site for a Li filament (Ref. 7). Krauskopf et al. studied the formation of voids in the absence of stack pressure when vacancies that are created at the interface during dissolution of Li from the electrode cannot diffuse away from the interface as fast as they are being created (Ref. 13). This leads to a decrease in interfacial contact area, which corresponds with an increase in interfacial impedance and lower CCD.

It has also shown that the interface/interphase between Li and the SSE plays an important role in determining the current density at which Li penetration is observed. In LLZO, reduction of interfacial impedance through rigorous surface cleaning and/or interfacial layers, has enabled current densities up to 1-2 mA/cm² for planar cells at room temperature (Ref. 7, 8, 18, 19). Li⁷ NMR chemical shift imaging was used to show that morphology evolution at both the plating and stripping interfaces is linked with the Li penetration (Ref. 20). Interphase formation between Li metal and Li_{1.4}Al_{0.4}Ge_{1.6}(PO₄)₃ (LAGP) has also been shown to play a role in mechanical fracture of the bulk SSE during cycling (Ref. 21).

Given the breadth of proposed mechanisms that drive Li nucleation and propagation in SSEs, there is a need for additional operando investigations to elucidate the nature and dynamic evolution of Li penetration during cycling under realistic conditions (Ref. 5, 12, 22). Filling the knowledge gaps mentioned above would provide researchers and engineers with the tools and knowledge needed to design high performance LMSSBs. Towards this goal, this example implemented an operando visualization technique that enabled high-quality optical observations within the bulk of LLZO during cycling at relevant current densities (>1 mA/cm²) with low interfacial resistances (<5 Ω-cm²). The time-synchronization of voltage response (voltage trace) with video microscopy enables significant new insights into the mechanisms that lead to the coupled electro-chemo-mechanical response of the system (Ref. 23, 24).

Al-doped LLZO was used as a model system for this example, as the inherent chemical stability against Li metal simplifies the analysis, and translucent/transparent electrolyte films can be fabricated based on recent advances in material processing (Ref. 25). In addition, the mechanical and transport properties have been well-documented (Ref. 26-29), allowing for a detailed analysis. Using both through-plane and in-plane cell geometries, Li penetration was imaged in-operando during propagation and time-synchronized with the corresponding electrochemical signatures. In addition, reversible plating and stripping of the Li within these structures and the formation of “dead Li” during cycling, were directly observed. Four distinct morphologies of Li filaments were identified and described using a combination of operando optical and post-mortem electron microscopy, illustrating that a singular mechanism/mode of failure is insufficient to capture the full complexity of Li penetration in SSEs. The velocity of Li filament propagation was quantified as a function of applied current density, providing insight into the coupling between mechanical and electrochemical behavior. The behavior during deep discharge was examined, and the dynamic evolution of the Li/SSE interfacial area was quantified and correlated with changes in interface resistance. Finally, the in-plane platform was applied to a glassy Li₃PS₄ SSE, demonstrating the power of the in-plane architecture and the implications of the results for SSEs more broadly.

### Through-Plane Operando Visualization

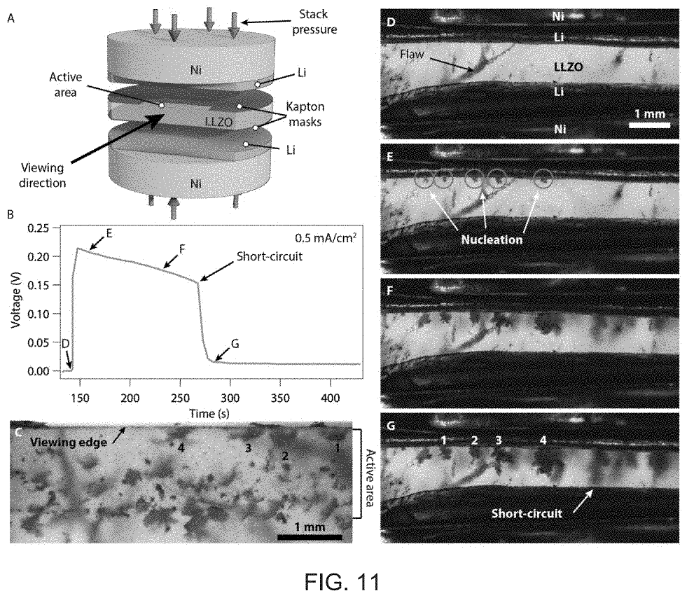

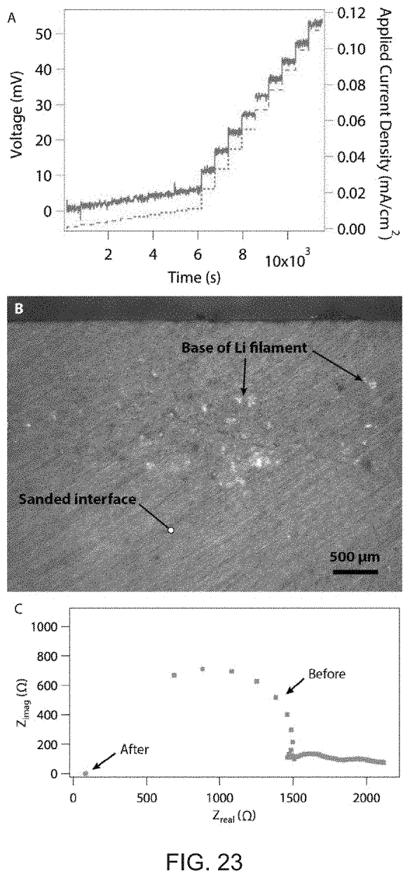

First, the through-plane cell shown in FIG. 11 was fabricated by cutting an LLZO pellet and polishing the cut surface to view the cross-section during cycling. Initially, when currents <0.1 mA/cm² were applied, no changes to the electrode or electrolyte morphology were observed. The stable voltage response to successively increasing current densities below the CCD is shown in FIG. 23. As shown in FIG. 11, when a current density of 0.5 mA/cm² is applied, Li filaments immediately nucleate and a gradual drop in polarization occurs as the filaments propagate across the cell. The Li penetration appears as branching 3D structures, and are dark silhouettes due to the back lighting. This continues until one filament reaches the counter electrode, corresponding with a simultaneous rapid drop in polarization to near zero when short-circuit occurs (2.5 seconds). This is expected when an electronically conductive pathway of metallic Li is formed between the two electrodes.

The gradual decrease in polarization while the filaments propagate towards the counter electrode can be explained as a result of three factors: [1] an increase in active interfacial area of the cathodic electrode as the structures grow, which decreases interfacial impedance; [2] a decrease in distance between the Li filament and the anode, decreasing the impedance associated with ionic conduction in the SSE (Ref. 20); and [3] formation of a kinetically faster interface for charge transfer, similar to dendrites in liquid electrolytes (Ref. 23). This demonstrates the power of the operando video microscopy platform to provide mechanistic insight into the origins of electrochemical signatures, which can be used in real battery applications where optical access to the cell is not available. For example, this characteristic drop in cell voltage could be used to identify the propagation of a Li filament in one cell of a battery pack with on-board diagnostics during charging to avoid a catastrophic short-circuit failure.

Although the results from this experiment provide valuable insights and clearly show the propagation of Li filaments and the synchronized voltage trace, this platform is not ideal to enable high-resolution imaging and post-mortem analysis. First, this setup requires a very transparent SSE material, and while this is possible to achieve in LLZO, it requires high sintering temperatures (>1300° C.) and long sintering times to achieve large-grained, high density pellets (Ref. 25). This makes throughput very low, and it is difficult to make comparisons to SSEs with conventional processing. In addition, the geometry of the cell means that the electrode edges are preferred nucleation sites. A majority of the filaments nucleated either at the viewing edge or at the opposite edge of the active area.

### The In-Plane Visualization Platform

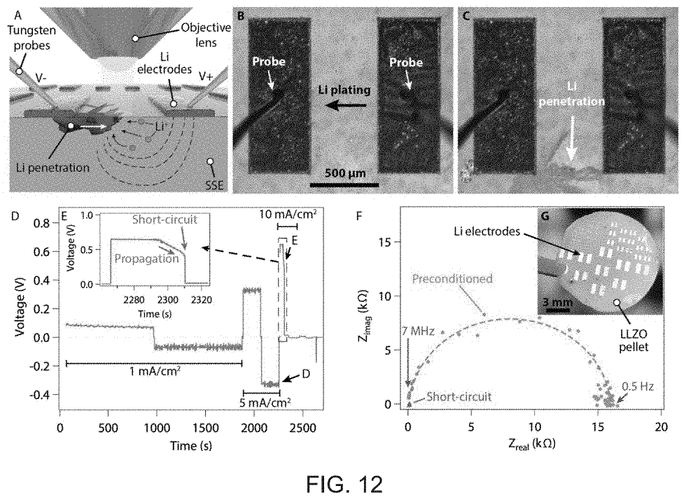

To overcome challenges with the through-plane platform, an in-plane electrode architecture was developed that enables: [1] high-quality interfaces with low interfacial impedance; [2] improved optical imaging; [3] higher throughput; [4] use of representative SSE materials; and [5] quantitative operando and post-mortem analysis without the need to remove electrodes. A schematic of this cell geometry is shown in A of FIG. 12. By depositing both electrodes on the same surface of a polished LLZO pellet, Li filaments that grow can be clearly observed as they propagate between the two electrodes.

This architecture allows for many cells to be fabricated on the same SSE pellet. For example, G in FIG. 12 shows 39 pairs of electrodes of 3 different sizes all fabricated in parallel by thermal evaporation of Li through a shadow mask. This enables direct comparison of cells under different operating conditions (current density, depth of discharge, etc.) with an identical SSE. Furthermore, after any individual cell has short-circuited via Li penetration, the SSE can continue to be tested in adjacent cells.

### Experimental Validation of the In-Plane Visualization Platform

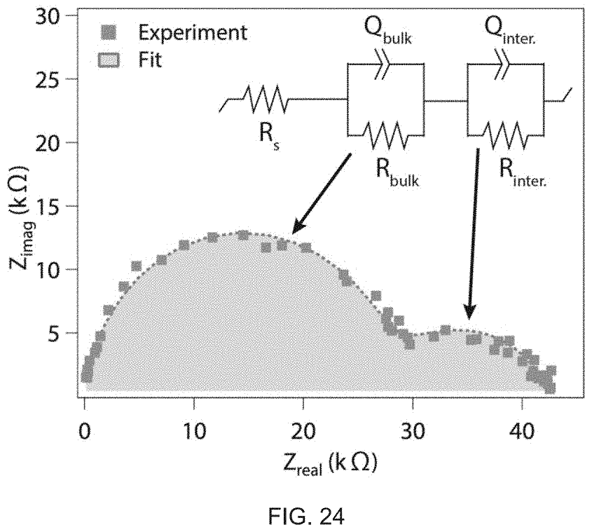

To validate the in-plane geometry experimentally, CCD tests were performed that mirror those typically used to demonstrate rate capability of SSEs (Ref. 6, 18, 19, 30). Any representative platform for operando characterization should be capable of cycling Li at sufficiently high current densities (>0.5 mA/cm²) and cell polarization (<1 V) without Li penetration. To achieve this, a clean Li/LLZO surface was formed by a combination of polishing and heat treatment, which has been previously shown to eliminate interfacial impedance and improve wettability of molten Li (Ref. 6). Li metal electrodes were deposited by thermal evaporation and heated to 250° C. without stack pressure for 5 minutes, then cooled to room-temperature. This process melted the Li and improved Li-LLZO contact. The Nyquist plot from EIS analysis after this heat-treatment in F of FIG. 12 shows a single semi-circular feature, indicative of interfacial impedance below what could be detected by EIS in this case (<5 Ω-cm²). An example of EIS on a pair of as-deposited electrodes is shown in FIG. 24 for comparison, and exhibits a second semicircle from the interfacial impedance at low frequencies (Ref. 31).

To compare the behavior of the in-plane cell to typical bulk SSE cells, a constant charge of 0.25 mAh/cm² was plated in each direction, and then current was successively increased until short-circuit was observed. Under these or similar conditions, the highest reported CCDs at room temperature for planar LLZO samples without an interlayer coating is ˜1 mA/cm² with an applied stack pressure (Ref. 7, 19). A Li/Mg alloy electrode (Ref. 8) and an MoS2 interlayer (Ref. 18) have been demonstrated to ˜2 mA/cm². In this in-plane cell, even without any stack pressure, flat voltage plateaus and no Li filaments were observed at 1 and 5 mA/cm² (see B,D in FIG. 12). At 10 mA/cm², a small feature grows from the bottom left corner of the left-hand electrode, but no significant change is observed in the voltage profile, and the structure stops growing fairly quickly. This will be called a “spalling type” morphology, and will be described in more detail below. After 30 seconds of plating, a branching structure grows out from the bottom right corner of the electrode towards the other side. As this Li filament grows, the cell polarization drops steadily (E in FIG. 12), similar to the drop observed as the filaments propagated in the through-plane cell above. After ˜15 more seconds, a sudden drop in cell impedance is observed when the filament reaches the opposite electrode and provides an electronic pathway.

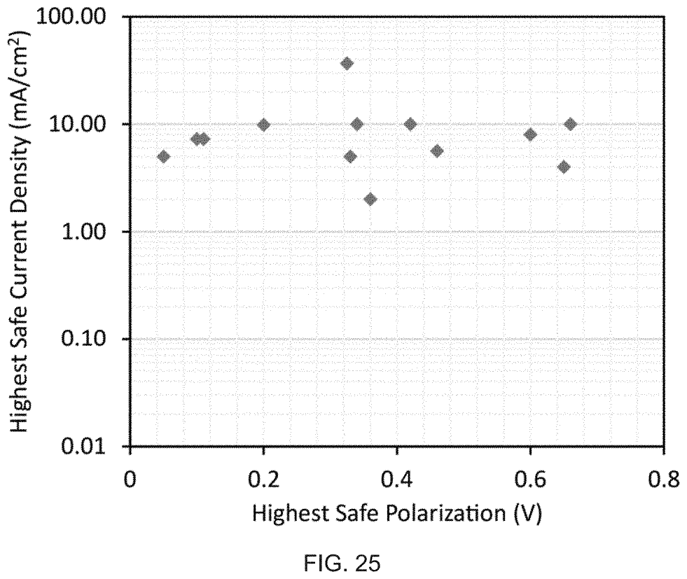

Overall, the in-plane cell closely mirrors what is seen in “typical” through-plane LLZO cells (Ref. 10, 32), but occurs at significantly higher current density (˜5-10× higher). The rate capability was consistently high in cells with annealed Li, as shown in FIG. 25, where the highest safe current density (where Li penetration was not observed) is plotted with the corresponding cell polarization for each of the equivalent cells tested. Another example of this is where smaller current steps were used, and the cell survived 10 mA/cm² with no signs of Li penetration. This high rate capability is likely a result of two factors: [1] smaller electrode area, meaning there is a smaller chance of a large/critical flaw within the electrode (Ref. 33); and [2] the Li metal was melted, whereas in many studies the Li is heated to just below the melting temperature (Ref. 6, 32). This demonstrates that under some conditions, a Li-LLZO interface can be stabilized at high current densities without the need for stack pressure.

### Li Penetration Morphologies

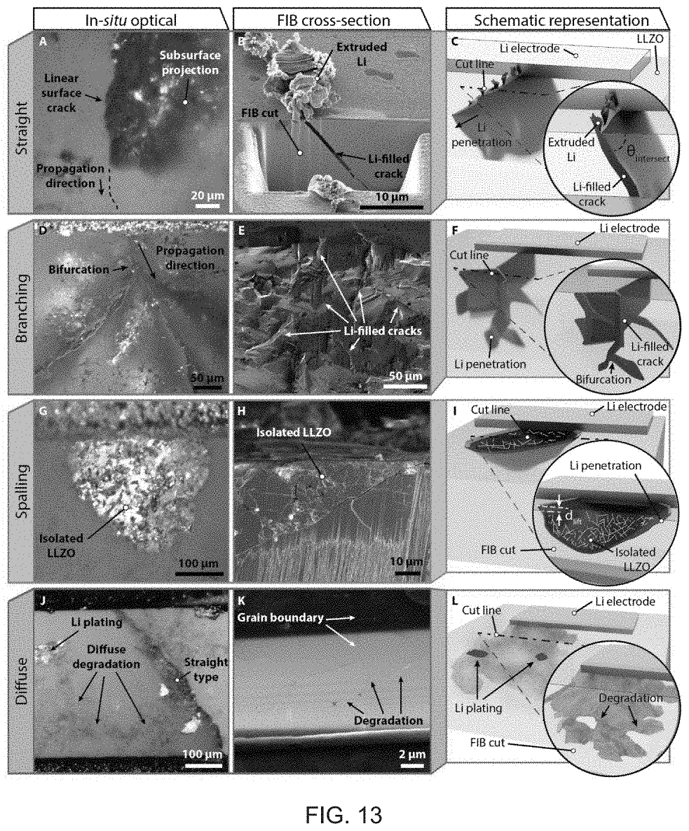

Several different types/morphologies of Li filaments were observed when cycling above the CCD. Here, we classify them into four groups, each of which is shown in FIG. 13. The first three, which we will refer to as “straight”, “spalling”, and “branching”, were commonly observed during these experiments, and appear similar in nature. The fourth, which we call “diffuse”, was less common, and was not observed in any of the optimized cells which had Li electrodes with low interfacial impedance (and high CCD). This type appears fundamentally different from the other three, as described below.

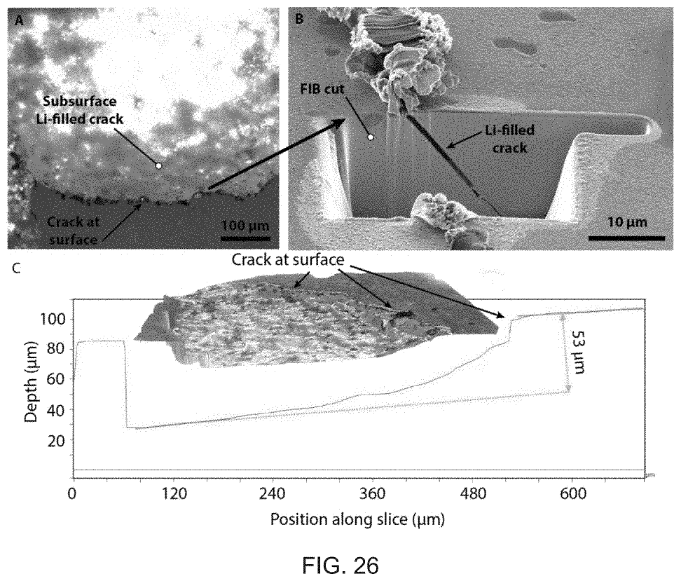

The straight type is shown in A-C of FIG. 13 and is typified by a single approximately linear path of propagation. The overall geometry is a subsurface plane intersecting the electrolyte surface as a linear crack. In the optical image shown in A of FIG. 13, the projection of the subsurface plane onto the top surface of the electrolyte appears as a dark region, with the linear surface crack visible as the left boundary. A 3D profile of this planar feature is shown in FIG. 26. This type of feature is often observed in post-mortem observations of typical LLZO cells after removing the Li electrodes (Ref. 10, 18). A focused ion beam (FIB) section of this feature shown in B of FIG. 13 reveals a cross-sectional view of the planar crack extending from the surface down into the electrolyte. The angle at which these cracks intersect the surface (θ_{intersect}) varies between individual cracks. These planar features are filled with metallic Li. This is evident from: [1] the metallic luster of the buried surfaces; [2] the extrusion of Li out of the crack at the surface (B,C in FIG. 13), which is a result of the viscoplasticity of metallic Li (Ref. 34, 35); and [3] the ability to strip Li from within the crack during subsequent cycling. Straight Li filaments are often responsible for short-circuit due to rapid propagation directly towards the opposite electrode.

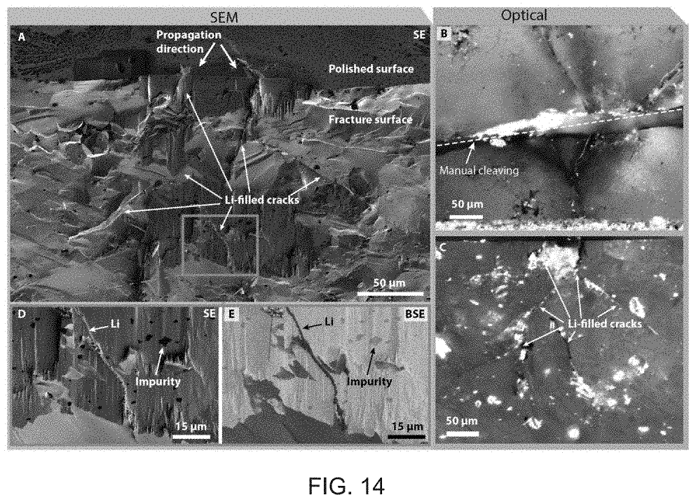

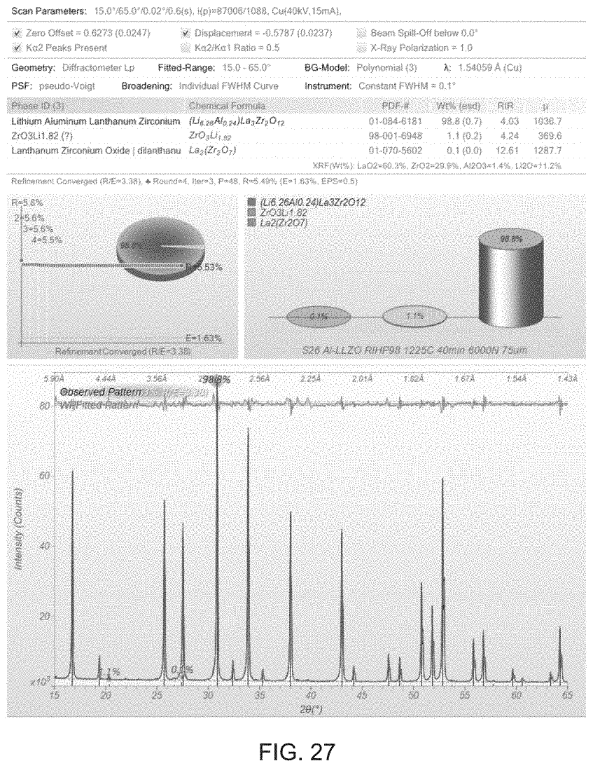

The second type of structure is “branching” (D-F in FIG. 13). It is typified by the dendritic, branching appearance that it is named for. In this type, there is a tendency for the crack to bifurcate as it grows. This leads to a 3-dimensional branching structure. Post-mortem characterization of a branching structure is shown in FIG. 14. The SSE was manually fractured through the structure (B in FIG. 14) and partially polished by FIB to reveal the subsurface features. A and C in FIG. 14 clearly show the branched planar structure in SEM and optical images, respectively. Each of the branches of these structures are Li-filled planes, as evidenced by the metallic luster in C of FIG. 14 and dramatically lower brightness in backscattered electron (BSE) imaging (E in FIG. 14). Isolated impurity grains are also visible in these images. X-ray diffraction analysis indicated that the LLZO pellet was very high purity (98.8% cubic garnet, 1.1 lithium zirconium oxide, and 0.1% lanthanum zirconium oxide, see FIG. 27). However, the small amount of impurities can be differentiated from the metallic Li in the BSE images, as the Li appears much darker due to z-contrast. These impurities were not a result of cycling, as they were observed in cells that had not been tested.

The exact cause of the branching/bifurcation is unknown, however in several cases during post-mortem FIB analysis, impurity grains were observed at the same locations where the crack bifurcated or deviated. A series of SEM images as the FIB removed thin slices of material was used to create a 3D reconstruction of one such location. This appears similar to crack deflection in ceramic matrix composites (Ref. 36-38). The ˜1% of impurities may play a significant role in determining the path of Li filament propagation.

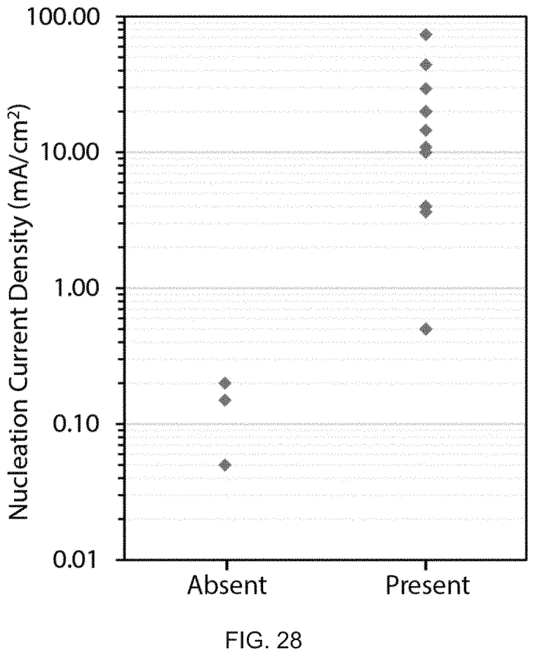

In the 18 in-plane cells examined, the branching type always occurred at high current densities, and never occurred at low current densities. As shown in FIG. 28, cells in which nucleation occurred below 0.2 mA/cm² never had the branching type, while in cells where nucleation occurred at above 0.3 mA/cm², the branching type was always one of the observed morphologies. This suggests that the bifurcation of cracks is linked to the higher driving force provided by the higher current density.

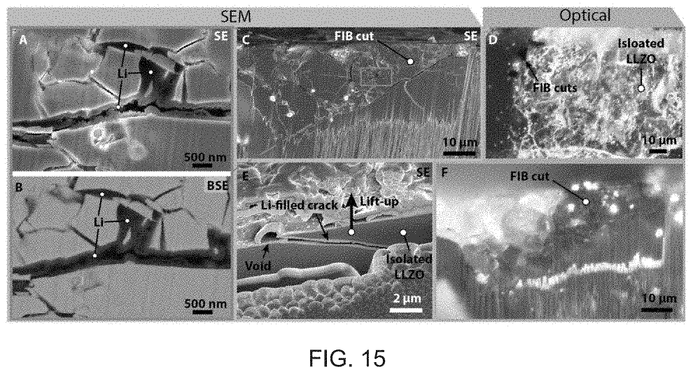

The third type, “spalling”, is named for the similarity in appearance to a piece of glass spalling off from a larger sheet (G-I in FIG. 13). In this case, a Li-filled crack similar to the straight type follows a curved path instead of a straight one. If a complete circle or closed loop is made by the crack at the surface, the LLZO in the center becomes isolated from the bulk of the pellet and can be lifted up (d_{lift}, I in FIG. 13, E in FIG. 15). As the addition of Li through electroplating inside the crack can be accommodated by the isolated region of the LLZO lifting up, there is no longer sufficient stress to propagate a crack further into the LLZO. At this point, the feature typically stops growing macroscopically, although Li is still being plated into the crack, so it is still “active”. Unlike the straight and branching types, the spalling type does not correlate with a decrease in polarization, and never led to short-circuit in the experiments run during the preparation of this manuscript. For these reasons, it was classified separately. The spalling-type feature shown in A-D,F of FIG. 15 has many cracks within the isolated section of LLZO that have pulverized that portion of the LLZO. These cracks grew during the plating rather than during the cross-sectioning of the sample, as they are filled with Li (A,B in FIG. 15). Not all spalling-type filaments exhibit this pulverization, however, some are a single crack like that in E of FIG. 15. The red coloration of the spalling feature after FIB sectioning in F of FIG. 15 is attributed to the reaction of metallic Li within the network of cracks with nitrogen to form lithium nitride, which has a characteristic reddish color.

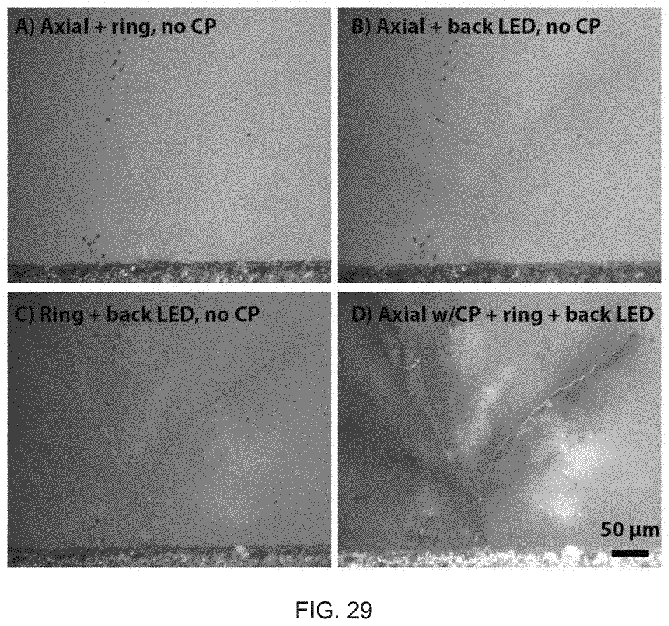

The final type of morphology, “diffuse”, was observed only twice during the preparation of this example, and was never observed in the optimized cells which had low interfacial impedance and high CCD. The operando video of a cell exhibited diffuse degradation. During the first three current densities (0.7, 0.8, 0.9 mA/cm²), there is no visible formation of Li filaments. During the 1 mA/cm² cycle, a subtle diffuse darkening within the SSE is observed. The strong backlighting helps to make the features more visible. As it propagates, a dark spot forms in between the two electrodes. Upon post-mortem optical inspection at higher magnification and with lighting from the top (J in FIG. 13), it is apparent that the diffuse darkening is due to the formation of a network of very thin structures, and the dark spot is Li metal that has plated out. The variety of lighting options enabled by the in-plane architecture make it possible to see the subtle changes (see FIG. 29).

As the diffuse darkening propagates and reaches the other side, there is almost no change in the cell polarization. A brief and very small drop is observed when the structure stops growing. This suggests that either the electronic conductivity of this feature is low, or that the “fuse effect” occurred almost instantaneously. This phenomena occurs when the electronically conductive pathway between electrodes is melted (like a fuse), and the pathway is broken (Ref. 39). When the polarity is reversed at 1.5 mA/cm², the structure does not noticeably shrink, but several more spots of Li plating in the middle are observed. Finally, during the last current pulse, a straight type Li filament grows across the cell and causes short-circuit.

K in FIG. 13 shows an FIB cross-section of a similar diffuse darkening structure. The presence of degradation along grain boundaries (visible both on the pellet surface and in the subsurface degradation) is dramatically different from the structures in the previous three types, and suggests that the propagation mechanism may be different. As this type was rare in cells with optimized interfaces, the remainder of the analysis focused on the first three types. This demonstrates that multiple types of

Li penetration can be observed in a given cell, further emphasizing that a single mechanism or explanation is insufficient to capture the full complexity of the observed phenomena. The multiple failure types are reminiscent of the multiple failure modes observed in Na β-Al₂O₃₈ SSEs (Ref. 40). Moving forward, it is important for the research community to note that the details of the SSE, interface, and test performed may impact the observed Li penetration dramatically.

### Reversibility and Cycling

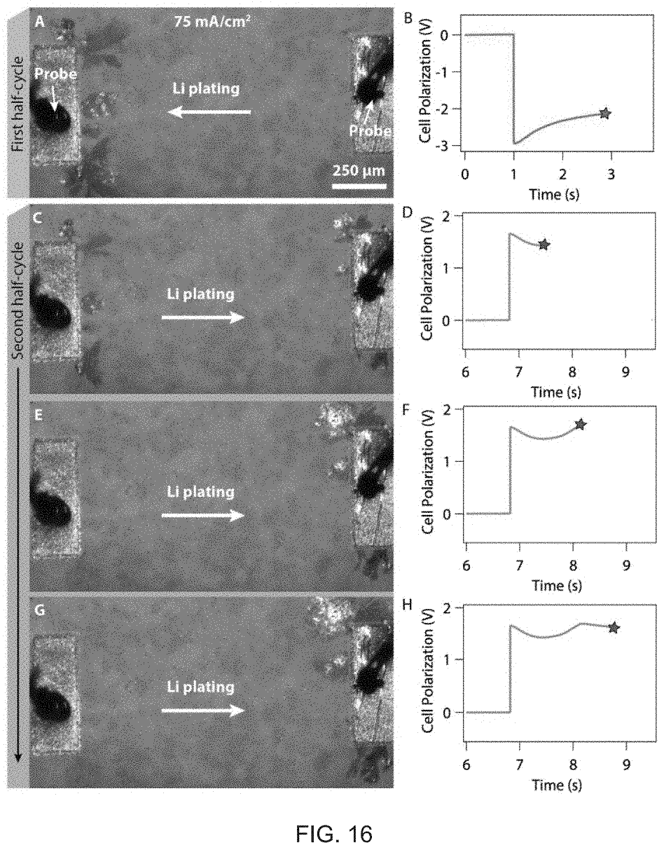

In addition to studying the conditions that lead to initial Li penetration and the morphology evolution of the interface under those conditions, the in-plane operando experimental platform is ideal for studying the dynamic evolution of filament morphology during cycling. To study this behavior, a cell with smaller electrodes ˜250 μm wide and ˜500 μm tall and a larger spacing between electrodes was used. The increased distance allows more time to observe Li filament propagation before short circuit occurs. To initially nucleate Li penetration, a two second pulse of high current at a nominal current density of 75 mA/cm² was applied. As shown in A of FIG. 16, several branching-type structures almost immediately nucleate at the left-hand electrode. As described above, the polarization gradually decreases as the branching structures grow.

When polarity is reversed at the same current for two seconds, the branching structures recede as Li is preferentially stripped from the surface of the Li filaments that grew during the first pulse. While this is happening, similar branching structures nucleate and grow on the opposite side (C in FIG. 16). Interestingly, nearly all of the Li can be removed from the structures leaving almost no visual evidence that the filaments had ever existed (E,G in FIG. 16). To the inventors' knowledge, this is the first time reversibility of Li penetration within an inorganic SSE has been reported. This behavior is very different from what was observed in a PEO-based polymer electrolyte, which exhibited little to no reversibility (Ref. 41).

Examination of the voltage trace in H of FIG. 16 during this pulse reveals several distinct features. The cell polarization initially drops, then reaches a minimum, then increases to a maximum value before again decreasing. Time-synchronized operando microscopy has been previously used to study Li metal electrodes in liquid electrolytes to understand the coupled electrochemical signatures and morphology (Ref. 23). In that work, a strikingly similar “peaking” profile in the voltage trace was observed. This voltage profile in liquid electrolytes is attributed to spatially varying kinetics along the electrode/electrolyte interface, and 3-electrode measurements allowed for the contributions from each electrode to be decoupled.

The preferential plating into and stripping from the dendritic structures suggests that there is a difference between the two interfaces. This behavior was also observed in liquid electrolytes, where it was attributed to a thinner solid electrolyte interphase (SEI) on the freshly plated Li inside the dendritic structures. A similar mechanism is likely occurring in the LLZO. Despite all efforts to create a clean and pristine LLZO interface prior to Li evaporation, it is known that some contamination remains (Ref. 42). In contrast, when a dendritic structure forms, the newly formed Li/LLZO interface is truly pristine. For this reason, Li plating into the dendritic structures is the preferred reaction pathway.

As mentioned above, the initial decrease in polarization during the first pulse (B in FIG. 16) is a result of increasing surface area and the decreasing distance between the electrodes. When polarity is reversed, new Li filaments nucleate and grow on the right-hand electrode. This leads to the initial drop in voltage during the second pulse. The minimum/valley corresponds to the time during which Li is being stripped primarily from the branching structures on the left, and plated into the branching structures on the right (C,D in FIG. 16). During this period, both plating and stripping are occurring on kinetically fast surfaces, and thus the overpotentials are low.

As the Li inside the branching structures on the left starts to be exhausted, the polarization begins to rise. The peak occurs at the same moment when the Li is exhausted from the Li filaments on the left (E,F in FIG. 16). Stripping is forced to proceed from the less-preferred (kinetically slower) interface that was formed by evaporation. After the peak, the polarization slowly decreases again due to the continued propagation of the Li filaments on the right (G,H in FIG. 16).

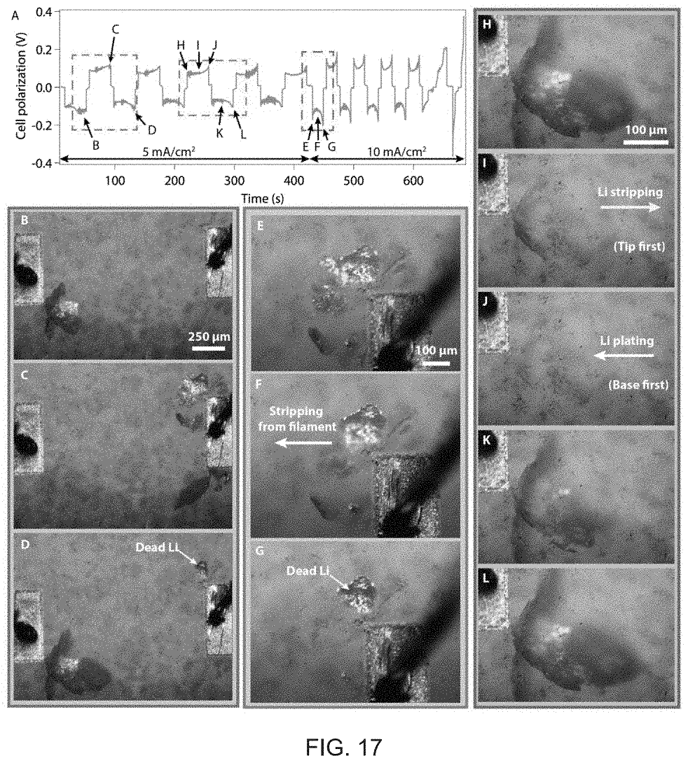

Following this initial cycle at high current density, the same amount of charge was repeatedly cycled at nominal current densities of 5 mA/cm² (5 cycles) and then 10 mA/cm² (5 cycles), as shown in FIG. 17. During the first half-cycle at 5 mA/cm², Li is plated back into one of the dendritic structures on the left that formed during the initial high current pulse (B in FIG. 17). This indicates that despite the structure disappearing optically, the crack that remains after stripping acts as a preferential site for Li plating during subsequent cycling. Interestingly, no Li is plated back into the other Li penetration sites. It is unclear why this is the case, however it could be the result of void formation in the Li electrode at the base of the crack during the previous stripping, similar to the void shown in E in FIG. 15. As cycling continues, the structures on both sides propagate slightly further each time they are plated into.

Although the structures appeared fully reversible during the first cycle, one of the branching structures had visible Li remaining after the second cycle (D in FIG. 17). This Li became electrically isolated from the rest of the electrode, and thus it is now inactive or “dead”. The formation of “dead Li” is well documented in liquid electrolyte systems, but has not been reported previously in SSEs. The formation of dead Li occurs by a similar mechanism to that in liquid cells, with Li stripped out of the base of the Li filament removing the electrical pathway to the rest of the electrode. However, unlike liquid electrolytes, an insulating SEI does not form around the isolated Li region. Therefore, when Li is plated back into the base, the “dead” Li can be reconnected to the bulk electrode and grow larger. Despite this, the base remains a “hot spot” for Li stripping and therefore, in each subsequent stripping half-cycle, the “dead Li” reforms. A higher magnification sequence of images is shown of the same dead Li during a later cycle in E-G in FIG. 17.

H-L in FIG. 17 show higher magnification set of images from a movie, which captures the stripping from and plating into the branching structure on the left electrode. Li is first removed from the “tips” of the filament (closest to the counter electrode), and the structure appears to contract back towards the base. When polarity is reversed, Li begins plating back into the structure first from the base and then out towards the tips. This indicates that the features of the structure that remain behind do not serve as an electronically conductive pathway, as in that case plating would begin at the tips. This effect could be significantly different in an SSE that reacted with Li metal and in which the resulting interphase could be electronically conductive (Li₁₀GeP₂S₁₂ for example) (Ref. 43).

Since the structures propagated slightly further each cycle, the structures from the two sides eventually met and short-circuit occurred. In an actual battery, there would only be the potential to form Li filaments from the negative electrode, so failure in this way would not occur, but rather the filament from the Li electrode would reach all the way across to the positive electrode.

### Li-Filled Crack Growth Analysis

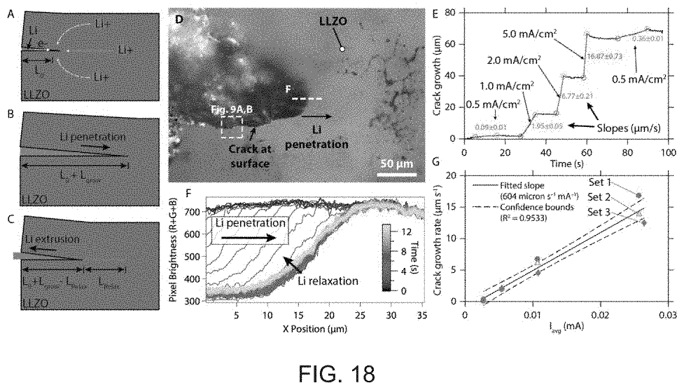

One of the primary benefits of the in-plane cell architecture is that the high-quality images can be used for quantitative analysis in ways that have not been possible previously. For example, the rate of Li filament propagation was measured as a function of applied current and a linear relationship was observed (see FIG. 18). The extension (L_{grow}) of a single straight-type Li filament was monitored during a sequence of galvanostatic pulses (A,B in FIG. 18). After each galvanostatic pulse, the electrodes were held at open-circuit potential, and the Li filament length was monitored to measure any change in crack length (Lᵣₑₗₐₓ; C in FIG. 18). The 3D morphology of the crack was captured after the experiment and is shown in FIG. 26.

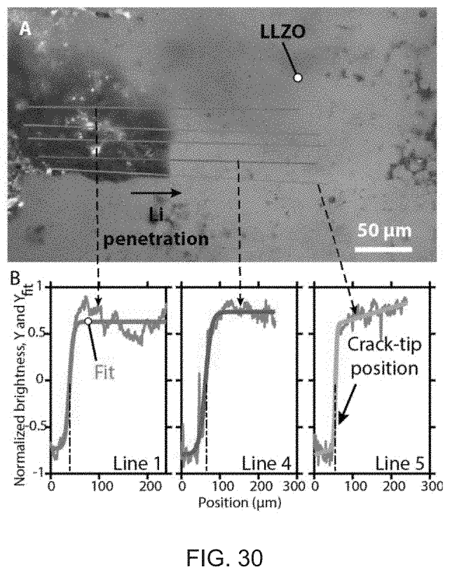

For each frame in the operando video, the extension of the leading edge of the Li filament was measured by fitting the abrupt increase in brightness between the darker Li filament and the brighter SSE ahead of the Li filament (D in FIG. 18). Further details of this method for tracking Li filament position are provided below and in FIG. 30.

The Li-filament position was measured during three sets of galvanostatic pulses. Each set consisted of pulses at nominal current densities of 0.5, 1, 2, and 5 mA/cm². The duration of the pulses was scaled to maintain the same charge for each current in each set. The rate of change in filament length was higher for pulses with higher current, as shown by the labelled slopes in E in FIG. 18. For the three sets of pulses, the crack growth rate was proportional to pulse current (G in FIG. 18). At the lowest pulse current, the crack growth rate approached zero, and the intersection of the fit with the x-axis is non-zero. This points to the existence of a critical threshold current for Li-filament propagation.

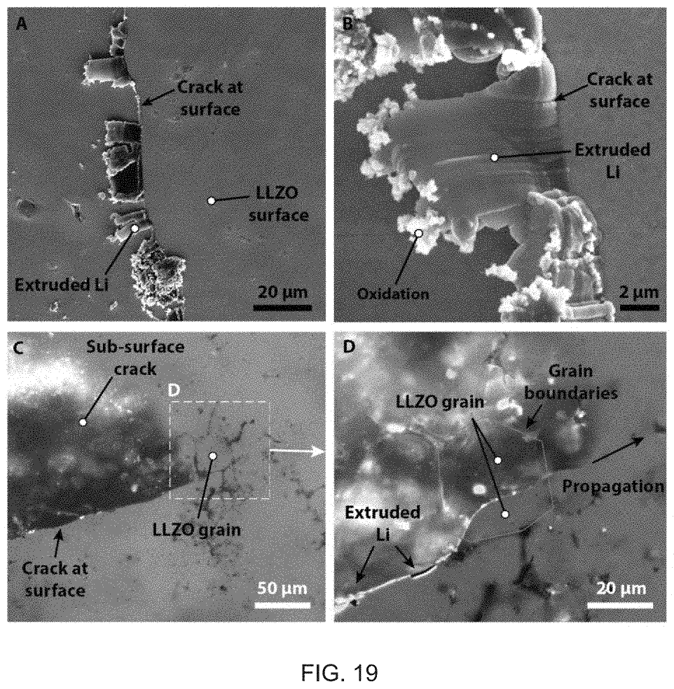

During open-circuit holds after the pulses above 1 mA/cm², the Li filament receded. For example, over a period of 6 seconds after a pulse of 5 mA/cm², the filament length shortened by Lᵣₑₗₐₓ≈3 μm (F in FIG. 18). A possible explanation for this Li filament relaxation stems from the viscoplastic mechanical response of Li. Within a range of conditions that are typical of Li metal batteries, the mechanical deformation of Li is strongly dependent on temperature and strain rate (Ref. 34, 35). Owing to this, Li is susceptible to creep at room temperature, which would allow the Li within a crack to extrude backwards when current is stopped. As further evidence of this behavior, Li that was extruded out of the crack is visible in post-mortem SEM (A,B in FIG. 19). The relaxation is more dramatic at higher current densities. This is consistent with the fact that the strain rate in Li increases with current density, which leads to a higher stress accumulation at the crack tip. When current is stopped, stress relaxation occurs and the Li filament recedes. This is further evidence that the Li within the crack is under compressive stress, and thus the propagation of the crack is mechanically driven.

On polished LLZO surfaces, grain boundaries are typically not easily visible in optical or electron microscopy. In some cases, however, the different properties of the grain boundaries make them visible. In C-D in FIG. 19, optical images show a Li filament propagate through the middle of a grain visible at the surface of the pellet. A video of this process was taken. This suggests that grain boundaries are not the only path of propagation for the straight-type Li filaments in LLZO. The video also shows Li being extruded from the crack at the surface.

### Deep Discharge and Void Formation

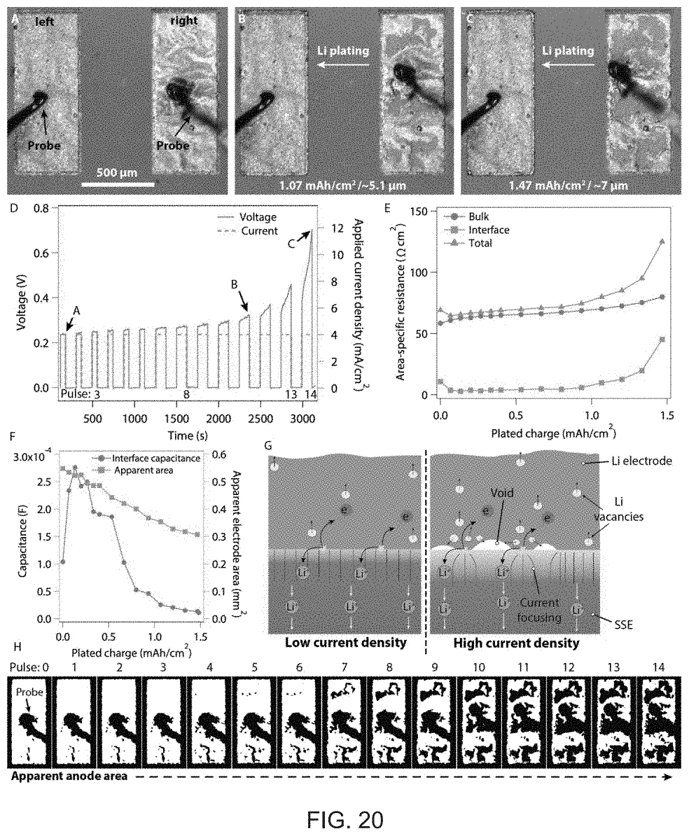

For Li metal batteries to outperform Li-ion, the amount of excess Li must be limited, as it is extra inactive weight and space in the cell. Thus, understanding the dynamic evolution of electrode morphology during deep discharge is of critical importance. To this end, current pulses of 4 mA/cm² (just below the measured CCD above) were applied, with a rest period and EIS measurement between each pulse. The resulting operando images and electrochemical response are shown in FIG. 20. In total, the six 1-minute pulses and eight 2-minute pulses total nearly 1.5 mAh/cm² (based on the original electrode area). This is equivalent to ˜7 μm of Li plating. Based on QCM measurements during the deposition of the electrodes, approximately 8 μm of Li was originally deposited, so this represents ˜85-90% of the total electrode mass being stripped.

As this Li was stripped (right to left in A-C in FIG. 20), areas of the LLZO beneath the electrode became visible as all of the Li was stripped from those regions. These locally depleted regions are visible throughout the electrode, confirming that the entire electrode area is active. The spatial variation in initiation and spread of these depleted regions may be attributed to several factors. First, as a result of the electrode fabrication process, slight thickness variations are present in the Li surface, which can be seen as “ripples” in A in FIG. 20. The thinner areas will be depleted first as stripping progresses. Additionally, spatially varying kinetics along the Li/SSE interface could lead to “hot spots” for stripping. The Li/Electrolyte interface is heterogeneous in nature, with grain boundaries, variations in surface chemistry, and grain orientation (in both the electrolyte and the Li metal) all potential sources of inhomogeneity (Ref. 5, 17, 23, 42, 44).

During the first pulse, a slight decrease in interfacial resistance is observed (F in FIG. 20), which may be attributed to improved interfacial contact when current flowed the first time. The cell polarization is fairly constant during pulses 1-9 (D in FIG. 20), and the EIS fitted with the equivalent circuit in FIG. 24 shows only small changes to the interfacial and bulk resistance (E in FIG. 20). In subsequent pulses, as the cell polarization starts to increase, the interface resistance also increases sharply. Nearly all of the increase in total impedance in the EIS is due to the interfaces.

To gain insight into the coupled electrochemical-morphological evolution of the system, the operando optical images were analyzed. Images corresponding to the end of each current pulse were converted to the binary images shown in H in FIG. 20, where the white regions represent metallic Li. The results of this analysis are shown in F in FIG. 20, where the apparent electrode area is plotted along with the interface capacitance extracted using EIS.

After the initial increase during the first current pulse, the capacitance exhibits a decreasing trend, as does the apparent electrode area. A decreasing capacitance with depth of charge was also observed in a recent study of Li/LLZO interfaces (Ref. 13). The apparent electrode area decreases approximately linearly with charge, while the capacitance exhibits a highly non-linear decrease. In particular, an abrupt drop in capacitance can be observed between 0.5 and 0.8 mAh/cm². Interestingly, this is also the depth of charge at which the interfacial resistance begins to increase dramatically (D,E in FIG. 20).

This deviation between capacitance and apparent electrode area is unexpected, as capacitance should scale linearly with area for an SSE/electrode interface (Ref. 45). This discrepancy could be a result of multiple factors, including: [1] the apparent electrode area not accurately representing the actual area of Li contact with the LLZO due to interfacial void formation; [2] chemical and/or structural heterogeneities along the Li/LLZO interface, which would affect the local capacitance along the interface. Both of these effects could also contribute to the increase in interfacial resistance with time, and will be discussed in further detail below.

As depicted in G in FIG. 20, at low current densities, diffusion of Li vacancies inside the Li metal electrode establishes a steady-state condition with the injection of Li⁺ into the SSE. As the apparent electrode area decreases (and current remains constant), the local current density increases. Eventually, vacancy diffusion cannot keep up and vacancies accumulate near the interface, coalescing into larger voids (Ref. 13). This further decreases the active area and results in current focusing at the contact points between the Li and the SSE, leading to faster void formation in a positive feedback loop.

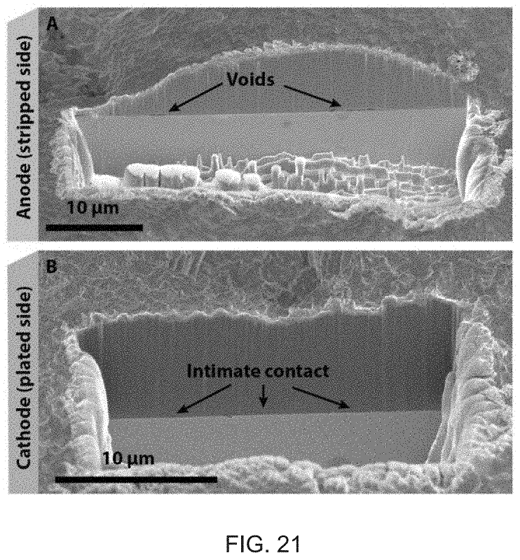

Representative SEM analysis on FIB cut cross-sections of the Li/LLZO interface confirms the presence of voids at the anodic interface (FIG. 21). The electrode that was stripped from has several voids, while the side that was plated onto has intimate contact between the Li and the LLZO along the interface. Multiple areas in both electrodes were examined to confirm this was a general trend. A video was taken that showed a 3D reconstruction of the stripping interface made using a series of cross-sectional FIB-SEM images. This is evidence that void formation contributes to the discrepancy between apparent electrode area and the measured capacitance, and to the increase in interfacial resistance.

Chemical and/or structural heterogeneities along the Li/LLZO interface could also contribute to the evolution of both interfacial resistance and capacitance over time. As Li will be preferentially removed from areas of the interface with faster kinetics (lower activation barrier), these areas will be exhausted of Li more quickly than areas which have slower kinetics. For example, we have previously shown that even after the LLZO surface preparation techniques used in the present work, a non-zero fraction of the surface has Li₂CO₃ present (Ref. 42). Furthermore, the presence of the “peaking” voltage behavior described in the reversibility and cycling section above indicates that the kinetics of the bulk Li-SSE interface are slower than at the new interface formed as Li propagation occurs.

As stripping proceeds at the anode, kinetically faster regions along the Li/SSE interface will experience higher local current densities. This will lead to faster vacancy accumulation in the Li in these regions, increasing the likelihood of void formation (G in FIG. 20). As a result, subsequent injection of Li⁺ ions into the SSE is forced to occur at locations with slower kinetics. The result is an increase in the area-specific resistance.

This demonstrates how interfacial heterogeneities may be ultimately responsible for the non-linear increase in interface resistance and decrease in interface capacitance observed at 0.5-0.8 mAh/cm² through the formation of voids.

The fact that stripping of Li at high rates leads to electrode morphology evolution in the form of depleted regions and voids indicates that the design of experimental conditions for evaluating rate capability should take into consideration the intended application. In any LMSSB, stripping of Li from the Li/SSE interface would occur during discharge of the battery, and plating would occur during charging. Thus, the formation of voids would occur during a fast discharge. For example, in EV or personal electronics applications, fast charge is more important than fast discharge, as the goal is to make the battery last at least several hours of use time. This suggests that an asymmetric cycling protocol may be a better indicator of performance than the symmetric tests above.

### Demonstration in a Sulfide Solid-State Electrolyte

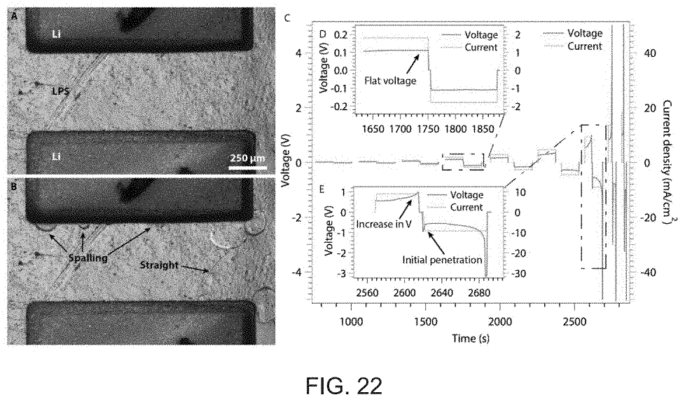

All of the experiments above were conducted in the model system of LLZO, but the in-plane architecture can be used in a range of SSE materials. For example, similar behavior to nearly all of the results in LLZO above was also observed in a glassy LPS material, where multiple morphologies (straight and spalling) nucleated in the cycle immediately following the first rapid increase in cell polarization during a current pulse. As shown in FIG. 22, the in-plane platform can be used even in electrolytes that have very limited transparency, as the features of interest are near to the electrolyte surface. The voltage profile corresponding to cycling shows that below the CCD, the voltage exhibits relatively flat plateaus for each current density (D in FIG. 22). At the CCD, a sharp rise is observed (due to void formation), and in the subsequent half cycle, Li penetration occurs (E in FIG. 22). This is similar to the results in the LLZO electrolytes.

This result shows the parallels between these two substantially different electrolyte systems. They have different anions (S vs. O), structure (glassy vs. garnet), electrochemical stability (narrow vs. wide), interphase formation (significant vs. little/none) (Ref. 3), but exhibit very similar Li propagation and electrode evolution in this case. This demonstrates the wider implications of this study for Li metal LMSSBs in general. At any Li/SSE interface, the morphology evolution of the Li metal electrode plays a key role in determining the rate capability. Whether that is Li penetration (of various types), void formation, or wetting/dewetting, it is critical to understand the coupled chemo-electrochemical-mechanical phenomena that drive interfacial performance and stability in LMSSBs.

### Conclusions

In this example, an in-plane cell geometry was demonstrated that enables high quality optical imaging of SSEs in-operando at battery-relevant current densities. With this platform, several key observations were made:
(1) Multiple different morphologies of Li penetration (straight, branching, spalling, and diffuse) are possible in LLZO solid electrolytes, indicating that a single mechanism is insufficient to explain the complexity of this system.
(2) The Li within these structures can be reversibly cycled, and the signatures of this are evident in the corresponding voltage trace.
(3) At relatively high current densities, the most common types of Li filaments propagate by a mechanical crack-opening mechanism, and the rate of propagation is proportional to the current density.
(4) The morphology evolution of the Li electrode (void formation, dewetting, and reduction of contact area) during electrodissolution of Li at high rates demonstrates the importance of considering the impact of both plating and stripping on the Li/SSE interface.
(5) Similar Li penetration behavior was observed in a glassy LPS SSE, demonstrating the application of the in-plane architecture for other SSE materials.

These results provide significant new insight into the underlying mechanisms that drive failure in solid state electrolyte (SSE) materials, including how/why Li penetration and void formation occurs, what the nature of the structures is, and how they evolve during cycling. This understanding informs future work to suppress the formation of these structures and enable fast-charging of LMSSBs.

### Materials and Methods for Example 2

### Electrolyte Synthesis

Cubic Al-doped LLZO (Al-LLZO) with a nominal composition of Li_{6.25}Al_{0.25}La₃Zr₂O₁₂was prepared for the through-plane cell using the solid-state synthetic technique. The methodology has been explained elsewhere in more detail (Ref. 6, 26). A combination of hot-pressing and annealing was used to grow grains and prepare transparent LLZO specimen in this example. First, the calcined powder was densified using a rapid induction hot-press (RIHP) at 1100° C. under a uniaxial 62 MPa pressure for 1 hour in a graphite die under flowing argon atmosphere to achieve >97% relative density. Then, the hot-pressed pellets were embedded in LLZO mother powder with the same nominal composition and annealed in a tube furnace under flowing argon for 50 hours at 1300° C. Details about the method to prepare transparent LLZO can be found elsewhere (Ref. 26).

Al-LLZO samples for in-plane cells were synthesized from starting powders of Li₂CO₃, Al₂O₃, La₂O₃, and ZrO₂ from a solid-state reaction method, calcined at 1000° C. for 4 hours in dry air. Densification of Al-LLZO was achieved by Rapid Induction Hot Pressing (RIHP) green bodies of calcined Al-LLZO at 1225° C., 48 MPa for 40 minutes in an argon atmosphere.

For all pellets, polishing and surface preparation to attain low interfacial resistance was done following a previously reported procedure (Ref. 26), adding a final polishing step of 0.1 μm of diamond polishing abrasive for the in-plane cells before heat treatment at 400° C. for 3 hours in an Ar atmosphere.

The amorphous 25Li₂S-75P₂S₅ (mol %) solid electrolyte was synthesized from crystalline Li₂S (99.98%, Aldrich) and P₂S₅ (99%, Sigma Aldrich) by mechanochemical synthesis after being mixed in an agate mortar and pestle. The mixed precursors were placed in a 45 cc zirconia pot with 10 zirconia balls of 10 mm in diameter and 10 zirconia balls of 5 mm in diameter, sealed in a dry Ar-filled glovebox (water concentration below 0.5 ppm), placed inside stainless steel vessels and transported in an inert atmosphere. The pots were spun at 510 RPM for 10 hours in a Planetary Micro Mill (Pulverisette 7, Fritsch GmbH), with 2 hour intervals of milling followed by 10 minute rest intervals at room temperature. Milled LPS powder was hot-pressed at 200° C. for 4 hours at 270 MPa with a heating rate of 0.7° C. min⁻¹.

### Electrode Fabrication

Immediately following the heat treatment procedure, the LLZO pellets for the through-plane cells were pressed against Li foil (99.9%, Alfa Aesar) that had been scraped with a stainless steel spatula, with areas apart from the active surfaces masked with Kapton tape. In-plane cells were loaded into a glovebox-integrated thermal evaporator (Ångstrom Engineering Inc.). Laser-cut Ni foil was gently clamped on the pellet surface to define the geometry of the electrodes. Molten Li (99.9%, Alfa Aesar) in a Mo crucible was heated to 550° C. while the sample was spinning and thickness was monitored by quartz crystal microbalance until the desired thickness was reached.

### Optical Imaging

Optical imaging of the through-plane cell was performed with a 12 megapixel color camera (Amscope) and a 75 mm c-mount lens (Fujinon) in an Ar glovebox. A 3-watt white LED (Cree) with focusing optics was used for back-lighting while an LED ring light (Amscope) was used for top lighting.

In-plane cells were imaged using a Nikon LV-150 microscope in an Ar glovebox. A 5 megapixel color camera (IDS) was used to capture still images and video. 5×, 10×, 20×, and 50× objectives (Nikon) were used for various experiments. A halogen lamp was used for axial illumination with circular polarizers on the incoming light and in the imaging column for cross-polarization. A 3-watt white LED (Cree) with focusing optics was used for back-lighting while an LED ring light (Amscope) was used for top lighting. Varying the relative intensity of each light source allowed tunability to maximize image quality and contrast.

Extended depth of focus images shown in FIGS. 13 and 14 were made by recording images a range of focal positions and blending the images with “auto-blend layers” in Photoshop (Adobe). White balance, brightness, and contrast of the entire images was done using Photoshop or Lightroom (Adobe) to match realistic appearances and make features as clear as possible. The z-profile of the Li-filled crack shown in FIG. 18 was captured with a VHX-6000 digital microscope (Keyence) with cross-polarized lighting to reduce surface scattering.

### Electrochemical Measurements

Electrochemical measurements were conducted with an SP-200 potentiostat (Bio-Logic) connected to the sample through BNC feedthroughs into the glovebox. Through-plane cells were contacted through the Ni pins that applied stack pressure. In-plane cells were contacted with tungsten needles and xyz manipulators (Signatone).

### Image Processing

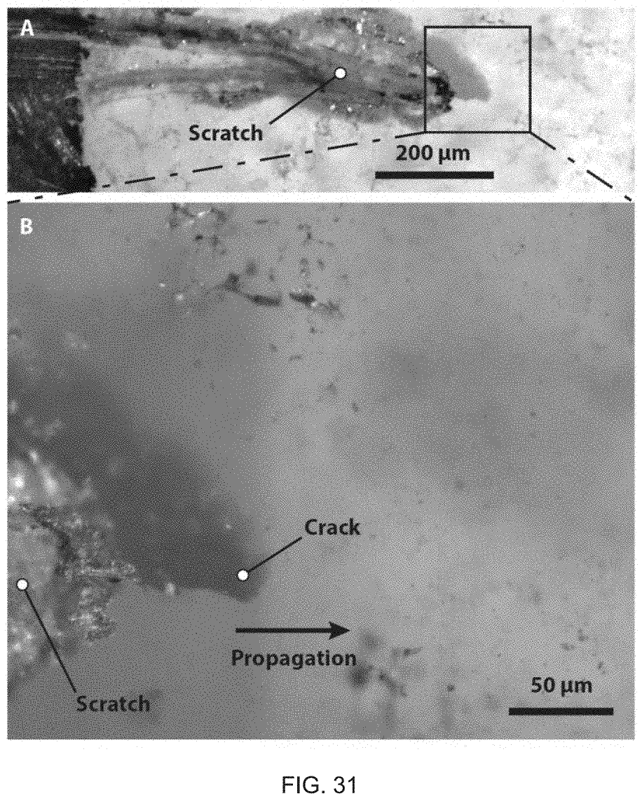

For the crack growth measurements, optical images were synchronized with corresponding electrochemical measurements using Matlab. The Li filament was initiated by first imparting a small scratch on the LLZO surface at the edge of the cathodic electrode with a diamond scribe and then plating Li at a nominal current density of 1 mA/cm² until the filament propagated beyond the end of the scratch by a distance (L₀) of ˜60 μm (FIG. 31). For each video frame, the Li-filament position was measured from the abrupt change in brightness along the leading edge of the Li filament. Each video frame was aligned with a reference image to remove vibration. Then the image brightness values were extracted for each pixel along 5 lines (5 pixels wide) that spanned across the Li filament and into the SSE ahead of the filament, in the direction of crack extension (FIG. 30). For each line, the image brightness was normalized between ˜1 and 1 for all of the frames during the galvanostatic pulses. For position along each line (x), the normalized image brightness (Y) was fitted with a brightness function (Y_{fit}). The objective function for minimization was (Y−Y_{fit})², with

Y_{fit}=A tan h[B(x−C)]+Dx+E.

The fitted function Y_{fit} utilized a hyperbolic tangent function with five fitting terms: brightness magnitude (A) of the hyperbolic tangent, crack position scale (B) and shift (C), linear brightness scaling (D), and brightness shift (E). The key fitting term of interest is the crack position shift (C), with the growth of the Li filament between frames given by the change in C.

For the analysis of electrode area during deep discharge, a color threshold on the R channel was applied in ImageJ. Then the image was converted to greyscale and another threshold was applied to convert the image to binary white and black. Outlier removal of both light and dark regions smaller than 20 pixels was used to reduce noise. Electrode area was then calculated by counting white pixels in each frame with Matlab.

### Electron Microscopy

Post-mortem electron microscopy and focused-ion-beam (FIB) cutting was performed on an FEI Helios 650 Nanolab dual beam SEM/FIB. Air exposure during transfer into the instrument was minimized, usually less than one minute between first air exposure and reaching 10⁻³ Torr vacuum levels, with UHV levels reached within 2 minutes after that. SEM imaging was performed at 1-2 kV accelerating voltage and 100 pA to minimize charging and other artifacts. FIB cross-sectioning and tomography was performed using Ga+ ions with an accelerating voltage of 30 kV and a beam current of 21 nA.

### 3D Reconstruction

Reconstruction of a series of SEM images during successive FIB polishing cuts was performed using the Avizo software package (Thermo Fisher Scientific Inc.). Images were aligned and shear-corrected, and a non-local means filter was applied for noise reduction. Subsequently, segmentation based on brightness was performed to assign regions of interest.

### Through-Plane Cell Discussion

Electrodes were defined by masking the surface of the sample everywhere but a 1.5 mm wide strip closest to the fractured surface. By doing so, any Li filaments that nucleated were close to the viewing surface and therefore provided good contrast (minimized scattering between the features and the objective), and were close to the focal plane of the lens. The cell was then placed between two nickel pins and a stack pressure of approximately 350 kPa was applied.

Backlighting was used to silhouette the Li features and make them more visible. This also resulted in contrast from flaws that resulted from hot-pressing and polishing (the dark features in D in FIG. 11). Electrochemical impedance spectroscopy (EIS) before cycling shows one large semi-circle at high frequencies, and 2 less well-defined features at lower frequencies (FIG. 23). The highest frequency feature is attributed to bulk ionic conduction, the second to conduction along grain boundaries, and the lowest frequency to interfacial impedance (Ref. 31). The frequency dependence of the EIS changed dramatically after short-circuit, appearing as a point on the real axis, indicating an electronic short, but with a significant resistance value around 100Ω. This is due to the small diameter of the Li filament and relatively long path, and is sometimes described as a “soft” short.

The post-mortem image shown in C in FIG. 11 confirms the 3D nature of the structures, as they again appear as branching structures when looking from a perspective perpendicular to the operando experiment. When the lighting is changed from behind the sample to a ring light around the objective lens, the metallic luster of the Li filaments is evident, as shown in FIG. 23.

### REFERENCES

1. G. Zubi, R. Dufo-López, M. Carvalho, G. Pasaoglu, The lithium-ion battery: State of the art and future perspectives. Renew. Sustain. Energy Rev. 89, 292-308 (2018).

2. Z. Gao et al., Promises, Challenges, and Recent Progress of Inorganic Solid-State Electrolytes for All-Solid-State Lithium Batteries. Adv. Mater. 30, 1-27 (2018).

3. Z. Zhang et al., New horizons for inorganic solid state ion conductors. Energy Environ. Sci. 11, 1945-1976 (2018).

4. A. Manthiram, X. Yu, S. Wang, Lithium battery chemistries enabled by solid-state electrolytes. Nat. Rev. Mater. 2, 16103 (2017).

5. L. Porz et al., Mechanism of Lithium Metal Penetration through Inorganic Solid Electrolytes. Adv. Energy Mater. 7, 1-12 (2017).

6. A. Sharafi et al., Surface Chemistry Mechanism of Ultra-Low Interfacial

Resistance in the Solid-State Electrolyte Li₇La₃Zr₂O₁₂. Chem. Mater. 29, 7961-7968 (2017).

7. M. Wang, J. B. Wolfenstine, J. Sakamoto, Temperature dependent flux balance of the Li/Li₇La₃Zr₂O₁2 interface. Electrochim. Acta. 296, 842-847 (2019).

8. C. Yang et al., An Electron/Ion Dual-Conductive Alloy Framework for High-Rate and High-Capacity Solid-State Lithium-Metal Batteries. Adv. Mater. 31, 1-7 (2019).

9. R. Garcia-Mendez, F. Mizuno, R. Zhang, T. S. Arthur, J. Sakamoto, Effect of Processing Conditions of 75Li₂S-25P₂S₅ Solid Electrolyte on its DC Electrochemical Behavior. Electrochim. Acta. 237, 144-151 (2017).

10. E. J. Cheng, A. Sharafi, J. Sakamoto, Intergranular Li metal propagation through polycrystalline Li_{6.25}Al_{0.25}La₃Zr₂O₁₂ ceramic electrolyte. Electrochim. Acta. 223, 85-91 (2017).

11. T. Swamy et al., Lithium Metal Penetration Induced by Electrodeposition through Solid Electrolytes: Example in Single-Crystal Li₆La₃ZrTaO₁₂ Garnet. J. Electrochem. Soc. 165, A3648-A3655 (2018).

12. F. Han et al., High electronic conductivity as the origin of lithium dendrite formation within solid electrolytes. Nat. Energy. 4, 187-196 (2019).

13. T. Krauskopf, H. Hartmann, W. G. Zeier, J. Janek, Toward a Fundamental Understanding of the Lithium Metal Anode in Solid-State Batteries—An Electrochemo-Mechanical Study on the Garnet-Type Solid Electrolyte Li_{6.25}Al_{0.25}La₃Zr₂O₁₂. ACS Appl. Mater. Interfaces. 11, 14463-14477 (2019).

14. F. Shen, M. B. Dixit, X. Xiao, K. B. Hatzell, Effect of Pore Connectivity on

Li Dendrite Propagation within LLZO Electrolytes Observed with Synchrotron X-ray Tomography. ACS Energy Lett. 3, 1056-1061 (2018).

15. J. Wolfenstine, J. L. Allen, J. Sakamoto, D. J. Siegel, H. Choe, Mechanical behavior of Li− ion-conducting crystalline oxide-based solid electrolytes: a brief review. Ionics (Kiel)., 1-6 (2017).

16. T. Swamy et al., Lithium Metal Penetration Induced by Electrodeposition through Solid Electrolytes: Example in Single-Crystal Li₆La₃ZrTaO₁₂ Garnet, J. Electrochem. Soc. 165, A3648-A3655 (2018).

17. Y. Song et al., Revealing the Short-Circuiting Mechanism of Garnet-Based Solid-State Electrolyte. Adv. Energy Mater. 1900671, 1900671 (2019).

18. J. Fu et al., In situ formation of a bifunctional interlayer enabled by a conversion reaction to initiatively prevent lithium dendrites in a garnet solid electrolyte. Energy Environ. Sci. 12, 1404-1412 (2019).

19. X. Huang et al., None-Mother-Powder Method to Prepare Dense Li-Garnet Solid Electrolytes with High Critical Current Density. ACS Appl. Energy Mater. 1, 5355-5365 (2018).

20. L. E. Marbella et al., 7 Li NMR Chemical Shift Imaging To Detect Microstructural Growth of Lithium in All-Solid-State Batteries. Chem. Mater. 31, 2762-2769 (2019).

21. J. A. Lewis et al., Interphase Morphology between a Solid-State Electrolyte and Lithium Controls Cell Failure. ACS Energy Lett. 4,591-599 (2019).

22. W. Manalastas et al., Mechanical failure of garnet electrolytes during Li electrodeposition observed by in-operando microscopy. J. Power Sources. 412, 287-293 (2019).

23. K. N. Wood et al., Dendrites and Pits: Untangling the Complex Behavior of Lithium Metal Anodes through Operando Video Microscopy. ACS Cent. Sci. 2,790-801 (2016).

24. K. N. Wood, M. Noked, N. P. Dasgupta, Lithium Metal Anodes: Toward an Improved Understanding of Coupled Morphological, Electrochemical, and Mechanical Behavior. ACS Energy Lett. 2,664-672 (2017).

25. A. Sharafi, C. G. Haslam, R. D. Kerns, J. Wolfenstine, J. Sakamoto, Controlling and correlating the effect of grain size with the mechanical and electrochemical properties of Li₇La₃Zr₂O₁₂ solid-state electrolyte. J. Mater. Chem. A. 5, 21491-21504 (2017).

26. W. E. Tenhaeff et al., Resolving the Grain Boundary and Lattice Impedance of Hot-Pressed Li₇La₃Zr₂O₁₂ Garnet Electrolytes. ChemElectroChem. 1, 375-378 (2014).

27. S. Yu et al., Elastic Properties of the Solid Electrolyte Li₇La₃Zr₂O₁₂ (LLZO). Chem. Mater. 28,197-206 (2016).

28. R. Murugan, V. Thangadurai, W. Weppner, Fast lithium ion conduction in garnet-type Li₇La₃Zr₂O₁₂. Angew. Chemie-Int. Ed. 46,7778-7781 (2007).

29. V. Thangadurai, S. Narayanan, D. Pinzaru, Garnet-type solid-state fast Li ion conductors for Li batteries: Critical review. Chem. Soc. Rev. 43,4714-4727 (2014).

30. Y. Lu et al., An: In situ element permeation constructed high endurance Li-LLZO interface at high current densities. J. Mater. Chem. A. 6,18853-18858 (2018).

31. A. Sharafi, H. M. Meyer, J. Nanda, J. Wolfenstine, J. Sakamoto, Characterizing the Li-Li₇La₃Zr₂O₁₂ interface stability and kinetics as a function of temperature and current density. J. Power Sources. 302, 135-139 (2016).

32. N. J. Taylor et al., Demonstration of high current densities and extended cycling in the garnet Li₇La₃Zr₂O₁₂ solid electrolyte, J. Power Sources. 396, 314-318 (2018).

33. K. Trustrum, Jayatilaka, Statistical approach to brittle fracture. J. Mater. Sci. 12, 1426-1430 (1977).

34. W. S. LePage et al., Lithium Mechanics: Roles of Strain Rate and Temperature and Implications for Lithium Metal Batteries. J. Electrochem. Soc. 166, A89-A97 (2019).

35. A. Masias, N. Felten, R. Garcia-Mendez, J. Wolfenstine, J. Sakamoto, Elastic, plastic, and creep mechanical properties of lithium metal, J. Mater. Sci. 54, 2585-2600 (2019).

36. Z. Xia et al., Direct observation of toughening mechanisms in carbon nanotube ceramic matrix composites. Acta Mater. 52, 931-944 (2004).

37. K. K. Chawla, in Composite Materials: Science and Engineering (Springer, New York, ed. 3rd, 2012; https://link.springer.com/book/10.1007%2F978-0-387-74365-3#toc), pp. 249-290.

38. K. M. Sevener, J. M. Tracy, Z. Chen, J. D. Kiser, S. Daly, Crack opening behavior in ceramic matrix composites. J. Am. Ceram. Soc. 100, 4734-4747 (2017).

39. M. Rosso et al., Dendrite short-circuit and fuse effect on Li/polymer/Li cells. Electrochim. Acta. 51, 5334-5340 (2006).

40. L. C. De Jonghe, L. Feldman, A. Beuchele, Slow degradation and electron conduction in sodium/beta-aluminas. J. Mater. Sci. 16, 780-786 (1981).

41. A. Gupta et al., Evaluating the Effects of Temperature and Pressure on Li/PEO-LiTFSI Interfacial Stability and Kinetics. J. Electrochem. Soc. 165, A2801-A2806 (2018).

42. A. Sharafi et al., Surface Chemistry Mechanism of Ultra-Low Interfacial Resistance in the Solid-State Electrolyte Li₇La₃Zr₂O₁₂. Chem. Mater. 29, 7961-7968 (2017).

43. S. Wenzel et al., Direct Observation of the Interfacial Instability of the Fast Ionic Conductor Li₁₀GeP₂S₁₂ at the Lithium Metal Anode. Chem. Mater. 28, 2400-2407 (2016).

44. S. Yu, D. J. Siegel, Grain Boundary Softening: A Potential Mechanism for Lithium Metal Penetration through Stiff Solid Electrolytes. ACS Appl. Mater. Interfaces.

10, 38151-38158 (2018).

45. X. Ge, C. Fu, S. H. Chan, Double layer capacitance of anode/solid-electrolyte interfaces. Phys. Chem. Chem. Phys. 13, 15134-15142 (2011).

The citation of any document is not to be construed as an admission that it is prior art with respect to the present invention.

Thus, the invention provides a means to achieve relevant charging rates without short-circuiting a lithium battery cell by limiting the electrode area, positioning the electrode where least defect population exist and controlling the external variables for stable lithium electrodeposition.

Although the invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein. Various features and advantages of the invention are set forth in the following claims.

What is claimed is:

1. An electrochemical device comprising:
a cathode;
a solid state electrolyte including a side having an electrolyte perimeter defining a surface area of the side of the solid state electrolyte; and
an anode including a surface region having an anode perimeter defining the surface region of the anode, the surface region of the anode being in contact with the solid state electrolyte,
wherein at least a portion of the anode perimeter is spaced inward of the electrolyte perimeter.

2. The electrochemical device of claim 1 wherein:
the entire anode perimeter is spaced inward of the electrolyte perimeter.

3. The electrochemical device of claim 1 wherein:
an area of the surface region of the anode is a percentage or less than the surface area of the side of the solid state electrolyte, and
the percentage is an integer between 0 and 100.

4. The electrochemical device of claim 1 wherein:
the area of the surface region of the anode is 90% or less than the surface area of the side of the solid state electrolyte.

5. The electrochemical device of claim 1 wherein:
the area of the surface region of the anode is 60% or less than the surface area of the side of the solid state electrolyte.

6. The electrochemical device of claim 1 wherein:
the area of the surface region of the anode is 30% or less than the surface area of the side of the solid state electrolyte.

7. The electrochemical device of claim 1, wherein the solid-state electrolyte comprises a material selected from the group consisting of lithium lanthanum zirconium oxide (LLZO), aluminum doped LLZO, tantalum doped LLZO, lithium aluminum titanium phosphate (LATP), lithium aluminum germanium phosphate (LAGP), lithium phosphorous sulfides, alkali metal cation-alumina, metal halides, and mixtures thereof.

8. The electrochemical device of claim 1, wherein the solid-state electrolyte comprises a material having the formula LiᵤReᵥM_{w}AₓO_{y}, wherein
Re can be any combination of elements with a nominal valance of +3 including La, Nd, Pr, Pm, Sm, Sc, Eu, Gd, Tb, Dy, Y, Ho, Er, Tm, Yb, and Lu;
M can be any combination of metals with a nominal valance of +3, +4, +5 or +6 including Zr, Ta, Nb, Sb, W, Hf, Sn, Ti, V, Bi, Ge, and Si;
A can be any combination of dopant atoms with nominal valance of +1, +2, +3 , or +4 including H, Na, K, Rb, Cs, Ba, Sr, Ca, Mg, Fe, Co, Ni, Cu, Zn, Ga, Al, B, and Mn;
u can vary from 3-7.5;
v can vary from 0-3;
w can vary from 0-2;
x can vary from 0-2; and
y can vary from 11-12.5.

9. The electrochemical device of claim 1, wherein the solid-state electrolyte comprises a lithium phosphorous sulfide.

10. The electrochemical device of claim 1, wherein an area of the surface region of the anode is less than 10 mm².

11. The electrochemical device of claim 1 wherein:
a critical current density of the electrochemical device is 1 mA/cm² or greater.

12. The electrochemical device of claim 1, wherein the anode consists essentially of lithium metal.

13. A method for forming an electrochemical device, the method comprising:
(a) providing a solid state electrolyte including a side having an electrolyte perimeter defining a surface area of the side of the solid state electrolyte; and
(b) placing the side of the solid state electrolyte in contact with a surface region of an electrode to form the electrochemical device, wherein the surface region of the electrode has an electrode perimeter defining the surface region of the electrode,
wherein at least a portion of the electrode perimeter is spaced inward of the electrolyte perimeter.

14. The method of claim 13 wherein:
the entire electrode perimeter is spaced inward of the electrolyte perimeter.

15. The method of claim 13 wherein:
an area of the surface region of the electrode is 60% or less than the surface area of the side of the solid state electrolyte.

16. The method of claim 13, wherein the solid-state electrolyte comprises a material selected from the group consisting of lithium lanthanum zirconium oxide (LLZO), aluminum doped LLZO, tantalum doped LLZO, lithium aluminum titanium phosphate (LATP), lithium aluminum germanium phosphate (LAGP), lithium phosphorous sulfides, alkali metal cation-alumina, metal halides, and mixtures thereof.

17. The method of claim 13 wherein:
the electrode consists essentially of lithium metal.

18. The method of claim 13 wherein:
step (b) comprises pressing the solid state electrolyte and the electrode together using a force in a range of 0.01 MPa to 10 MPa.

19. The method of claim 13 wherein:
step (b) comprises placing the side of the solid state electrolyte in contact with the surface region of the electrode to form the electrochemical device, wherein the surface region of the electrode is at least partially melted.

20. The method of claim 13 wherein:
the electrode consists essentially of an alkali metal, and
step (b) comprises pressing the solid state electrolyte and the electrode together using a load that is higher than a yield strength of the alkali metal.

21. A method for visualizing metal propagation from an anode into a solid state electrolyte during cycling of an electrochemical cell comprising the anode and the solid state electrolyte, the method comprising:
(a) providing an electrochemical cell comprising a cathode, an anode, and a solid state electrolyte, wherein the anode comprises a metal;
(b) repeatedly discharging and thereafter charging the cell at a current density; and
(c) recording metal propagation from the anode into the solid state electrolyte using video microscopy time-synchronized to applied current density.

22. The method of claim 21 further comprising:
(d) quantifying metal filament propagation as a function of the applied current density.

23. The method of claim 21 further comprising:
(d) recording voltage response of the cell during galvanostatic plating of the metal.

24. The method of claim 21 further comprising:
(d) imaging an interface of the anode and the solid state electrolyte after galvanostatic plating of the metal.

25. The method of claim 21 wherein:
step (a) comprises providing an electrochemical cell comprising a stack of the cathode, the anode, and the solid state electrolyte, and
step (c) comprises recording metal propagation from the anode into the solid state electrolyte using video microscopy in a viewing direction toward a cross-section of the stack of the cathode, the anode, and the solid state electrolyte.

26. The method of claim 21 wherein:
step (a) comprises providing an electrochemical cell comprising a solid state electrolyte having a surface, a cathode deposited on the surface of the solid state electrolyte, and an anode deposited on the surface of the solid state electrolyte in spaced relationship with the cathode, and
step (c) comprises recording metal propagation from the anode into the solid state electrolyte using video microscopy in a viewing direction toward the surface of the solid state electrolyte.

27. A method for charging an electrochemical device having a cathode, an anode, and a solid state electrolyte, the method comprising:
selecting a charging current density based on accumulated/irreversible damage of a cell of the electrochemical device.

28. The method of claim 27 further comprising:
determining the accumulated/irreversible damage by detecting deviation from ohmic behavior when applying a current density to the cell.
